(19) United States
(12) Patent Application Publication
(10) Pub. No.: US 2026/0100100 A1
(43) Pub. Date: Apr. 9, 2026

(54) ELECTRONIC GAMING SYSTEMS INCLUDING VARIOUS TRIGGERABLE BONUS FEATURES AND BONUS GAMES

(71) Applicant: Arisocrat Technologies, Inc., Las Vegas, NV (US)

(72) Inventor: Christmas Uberuaga, Reno, NV (US)

(21) Appl. No.: 19/059,430

(22) Filed: Feb. 21, 2025

Related U.S. Application Data
(60) Provisional application No. 63/703,536, filed on Oct. 4, 2024.

(51) Int. Cl. G07F 17/32

(52) U.S. Cl. CPC G07F 17/3267; G07F 17/3213

(57) ABSTRACT

An electronic gaming system includes a plurality of mechanical reels included in a first display device. The mechanical reels include a plurality of game symbols. The system also includes a game controller including a processor(s) configured to display on the first display device a base reel game played on the plurality of mechanical reels, and randomly generate a base reel game outcome using a single outcome table defining a plurality of outcome scenarios for the plurality of mechanical reels. Each outcome scenario of the plurality of outcome scenarios includes (i) a predetermined reel stop for each mechanical reel, and (ii) weighted factors. The processor(s) is also configured to determine that the base reel game outcome triggers a multiplier feature, a bonus hold-and-spin game, and/or a bonus wheel game, and display on a second display device the triggered multiplier feature, the triggered bonus hold-and-spin game, and/or the triggered bonus wheel game.

### CROSS REFERENCE TO RELATED APPLICATIONS

This application claims the benefit of priority to U.S. Provisional Ser. No. 63/703,536, filed Oct. 4, 2024, the contents of which are hereby incorporated by reference herein in its entirety.

### TECHNICAL FIELD

The field of disclosure relates generally to electronic gaming, and more specifically, to electronic gaming systems including both physical reels as well as a digital display to facilitate the playing of both base reel games as well as bonus games.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency, or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Notably, some games may include an element of skill on the part of the player and are therefore not entirely random.

### BRIEF DESCRIPTION

In one aspect, an electronic gaming system includes: a plurality of mechanical reels included in a first display device, the plurality of mechanical reels including a plurality of game symbols; at least one memory for storing instructions; and a game controller in communication with the at least one memory and each of the plurality of mechanical reels, the game controller including at least one processor, wherein when the instructions are executed by the at least one processor, the at least one processor is configured to: cause to be displayed on the first display device a base reel game played on the plurality of mechanical reels; randomly generate a base reel game outcome using a single outcome table defining a plurality of outcome scenarios for the plurality of mechanical reels, each outcome scenario of the plurality of outcome scenarios including (i) a predetermined reel stop for each of the plurality of mechanical reels, and (ii) a weighted factor; determine that the base reel game outcome triggers at least one of: a multiplier feature corresponding to a multiplier feature symbol included in the plurality of game symbols, a bonus hold-and-spin game corresponding to a hold-and-spin feature symbol included in the plurality of game symbols, or a bonus wheel game corresponding to at least one wheel feature symbol included in the plurality of game symbols; and cause to be displayed on a second display device at least one of the triggered multiplier feature, the triggered bonus hold-and-spin game, or the triggered bonus wheel game.

In another aspect, a method of electronic gaming implemented on an electronic gaming machine includes: causing to be displayed on a first display device a base reel game played on a plurality of mechanical reels, the plurality of mechanical reels including a plurality of game symbols; randomly generating a base reel game outcome using a single outcome table defining a plurality of outcome scenarios for the plurality of mechanical reels, each outcome scenario of the plurality of outcome scenarios including (i) a predetermined reel stop for each of the plurality of mechanical reels, and (ii) a weighted factor; determining that the base reel game outcome triggers at least one of: a multiplier feature corresponding to a multiplier feature symbol included in the plurality of game symbols, a bonus hold-and-spin game corresponding to a hold-and-spin feature symbol included in the plurality of game symbols, or a bonus wheel game corresponding to at least one wheel feature symbol included in the plurality of game symbols; and causing to be displayed on a second display device at least one of the triggered multiplier feature, the triggered bonus hold-and-spin game, or the triggered bonus wheel game.

In an additional aspect, a non-transitory computer-readable storage medium with instructions stored thereon is provided. The instructions, in response to execution by at least one processor, cause the at least one processor to: cause to be displayed on a first display device a base reel game played on a plurality of mechanical reels, the plurality of mechanical reels including a plurality of game symbols; randomly generate a base reel game outcome using a single outcome table defining a plurality of outcome scenarios for the plurality of mechanical reels, each outcome scenario of the plurality of outcome scenarios including (i) a predetermined reel stop for each of the plurality of mechanical reels, and (ii) a weighted factor; determine that the base reel game outcome triggers at least one of: a multiplier feature corresponding to a multiplier feature symbol included in the plurality of game symbols, a bonus hold-and-spin game corresponding to a hold-and-spin feature symbol included in the plurality of game symbols, or a bonus wheel game corresponding to at least one wheel feature symbol included in the plurality of game symbols; and cause to be displayed on a second display device at least one of the triggered multiplier feature, the triggered bonus hold-and-spin game, or the triggered bonus wheel game.

### BRIEF DESCRIPTION OF THE DRAWINGS

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4A is an example user interface or view of a first display device including a plurality of mechanical reels and displaying a base reel game for an example electronic game, in accordance with the present disclosure.

FIG. 4B is an example user interface or screenshot of a second display device displaying a base reel game for an example electronic game, in accordance with the present disclosure.

FIG. 5A is an example user interface or view of a plurality of mechanical reels of the base reel game for an example electronic game triggering a multiplier feature, in accordance with the present disclosure.

FIGS. 5B-5G are example user interfaces or screenshots of a sequence of the multiplier feature triggered by the base reel game of FIG. 5A, in accordance with the present disclosure.

FIG. 6A is an example user interface or view of a plurality of mechanical reels of the base reel game triggering a bonus hold-and-spin game, in accordance with the present disclosure.

FIGS. 6B and 6C are example user interfaces or screenshots of a sequence of the base game including a bonus indicator after triggering the bonus hold-and-spin game, in accordance with the present disclosure.

FIGS. 6D-6H are example user interfaces or screenshots of a sequence of a bonus hold-and-spin game triggered by the base reel game of FIG. 6A, in accordance with the present disclosure.

FIGS. 6I and 6J are example user interfaces or screenshots of a sequence of a multiplier feature triggered by the bonus hold-and-spin game of FIGS. 6D-6H, in accordance with the present disclosure.

FIG. 7A is an example user interface or view of a plurality of mechanical reels displaying a base reel game outcome for a base reel game, in accordance with the present disclosure.

FIG. 7B is an example user interface or screenshot of a bonus hold-and-spin game triggered by the base reel game of FIG. 7A, in accordance with the present disclosure.

FIG. 8A is an example user interface or view of a plurality of mechanical reels displaying the base reel game triggering a bonus wheel game, in accordance with the present disclosure.

FIGS. 8B-8D are example user interfaces or screenshots of a sequence of the bonus wheel game triggered by the base reel game of FIG. 8A, in accordance with the present disclosure.

FIG. 9 is an example, single outcome table defining various base reel game outcome scenarios for a plurality of mechanical reels, in accordance with the present disclosure.

### DETAILED DESCRIPTION

In some known electronic gaming systems, awards and/or outcomes of a primary game may present a game outcome as a reel game (e.g., a slot game) simulation. For example, an award value associated with a game outcome may be presented in the simulated reel game outcome as a symbol combination and/or one or more special symbols that correspond to the same award value. Additionally in some known games, the award value of the game outcome may desirably be partitioned or distributed across a base reel game outcome and one or more bonus game outcomes (e.g., outcomes of one or more free reel spins, wheel spins, or hold-and-spin). For example, an award value associated with one or more winning game patterns may be presented as being awarded in a base reel game outcome and one or more bonus game outcomes. However, not all known electronic games include secondary bonus games due to the difficulty and complexity of increased mathematical computations and/or winning probability scenarios (e.g., pay tables), as well as game cabinet limitations. For example, some game cabinets solely include physical or mechanical reels for playing a base reel game. Mechanical reels are finite and/or include a finite number of outcomes limited by the number of reel stops or positions included in the reels, as well as have a limit on the number of reels included within a cabinet. As such, incorporating additional bonus games is difficult, if not impossible in some instances.

Furthermore, with known electronic gaming systems that include physical reels for playing games, each reel is typically spun randomly and individually by internal controller or component (e.g., random number generator (RNG)) to increase variety and variations of the outcome during the gameplay. However, with physical reels, there are a finite number of reel stop positions. As such, although each individual reel is spun individually and at random, only a finite number of game outcomes for all the reels exists. Spinning each individual reel requires the game controller to generate distinct random outcomes for each reel during each play of the reel game. This in turn increases the processing power and/or processing need on internal controllers and computing systems operating the reel game including the physical reels. A need exists to address these limitations, while also improving on machine performance, memory storage and the overall functioning of the networked system controlling the gaming devices.

Embodiments of the present disclosure provide systems, program products, and methods for including a first display device including a plurality of physical reels and a second display device including a digital display to facilitate the ability to play both a base reel game on the physical reels and bonus game(s) on the digital display. The base reel game is played on the physical reels included in the first display device, while bonus games triggered by outcomes of the base reel game generated by the physical reels are played on the second, digital display device. The bonus games played on the second display device include a multiplier feature game, a hold-and-spin bonus game, and a wheel bonus game. By including both the physical or mechanical reels in the first display device, as well as the digital, second display device in the gaming system, games played thereon are expanded over known games that just include physical reels and the associated limitations.

Furthermore, embodiments of the present disclosure provide systems, program products, and methods of gameplay that utilize a single outcome table for randomly generating and/or determining base reel game outcomes. That is, a single outcome table included in the gaming system defines a number of outcome scenarios, the corresponding reel position for each of the plurality of reels included in the base reel game, and a weighted factor for each outcome scenario. As a result, when randomly generating the outcome for the base reel game, components of the system (e.g., RNG) only needs to generate a single number or pull corresponding to the single outcome table—not an individual number or pull for each of the plurality of reels.

The inclusion of the multiple display devices in the systems described herein, as well as the single outcome table utilized for determining base reel game outcomes, potentially increases the variability of the game, as well as improves control and assurance of RTP during the gameplay. Additionally, and to improve technical issues commonly experienced during gameplay, the inclusion of the single outcome table can also reduce the computational resources needed to operate the game when compared to known electronic games that need to generate random numbers or pulls for each of the plurality of reels for each game play.

The example systems, program products, and methods of the present disclosure represent a technical improvement in the field of electronic gaming. Technical improvements represented by the present disclosure include: (i) presenting Class II and Class III game outcomes as one or more outcomes of a bonus game added within a physical reel-based game; (ii) utilizing multiple bonus games to provide additional gameplay features/winning opportunities in addition to the gameplay of a physical reel-based game; (iii) increasing the flexibility and variability in presenting award values of a game outcome as one or more bonus game outcomes; (iv) displaying immediate bonus game feedback to a player; (v) reducing the computational resources needed as a result of a simplified gaming process that utilizes a single outcome table for a plurality of physical reels in a gaming system; and/or (vi) improved control and assurance of RTP by enabling control of the credit awards through the bonus games triggered by a physical reel-based game. Additional and/or alternative technical improvements may exist.

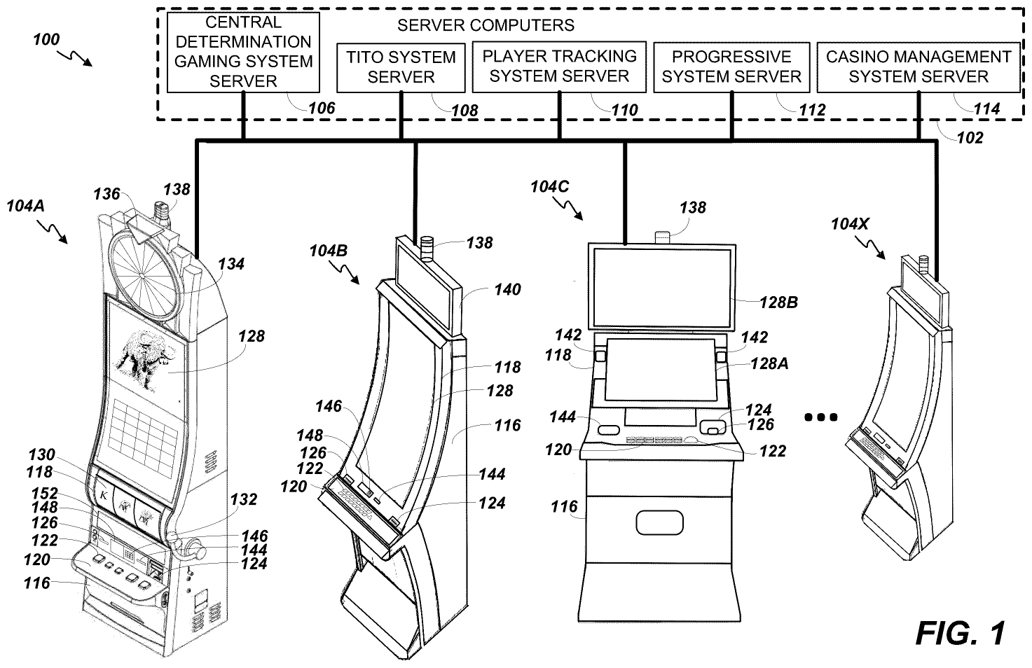

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

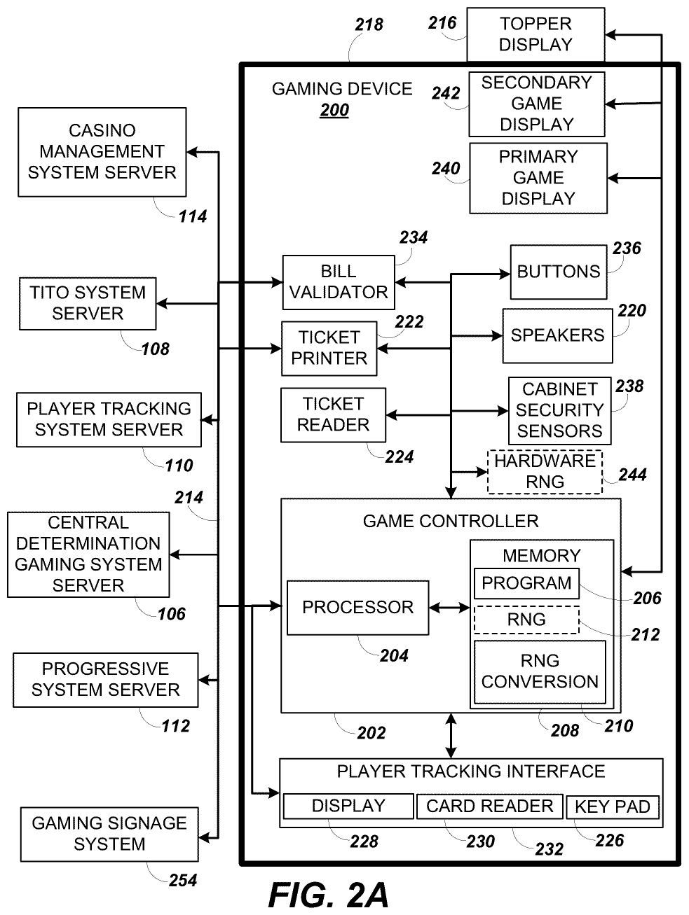

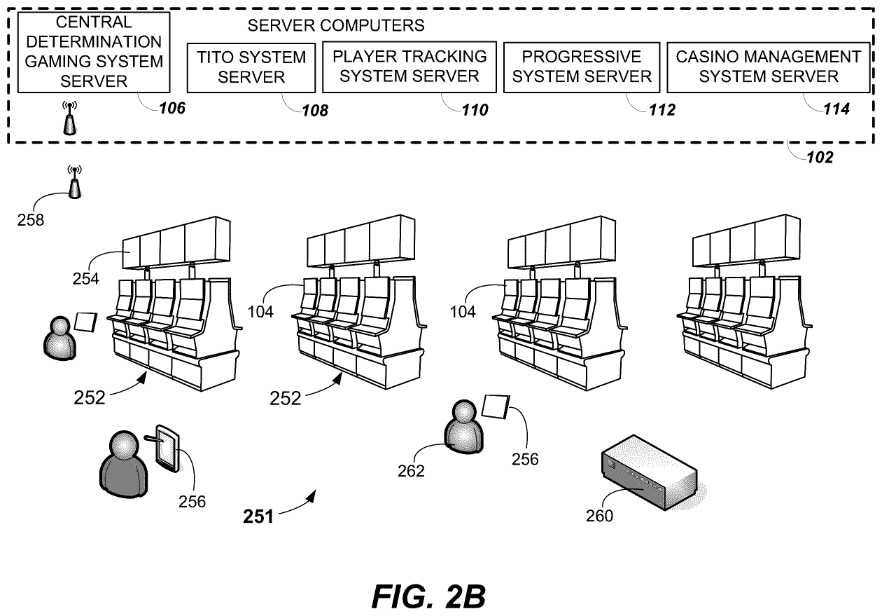

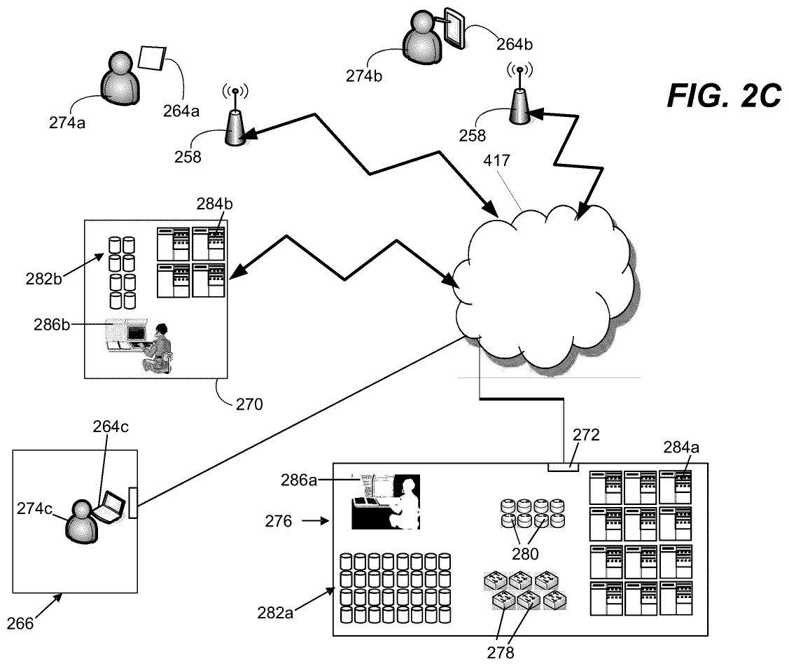

Many or all the above-described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play, or any other information or media desired by the game designer or operator. In some implementations, example gaming device 104C may also include speakers 142 to output various audio such as game sound, background music, etc.

Many different types of games, including mechanical slot games, video slot games, video poker, video blackjack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2A also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random-access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g., amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game displays 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding number of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types, and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

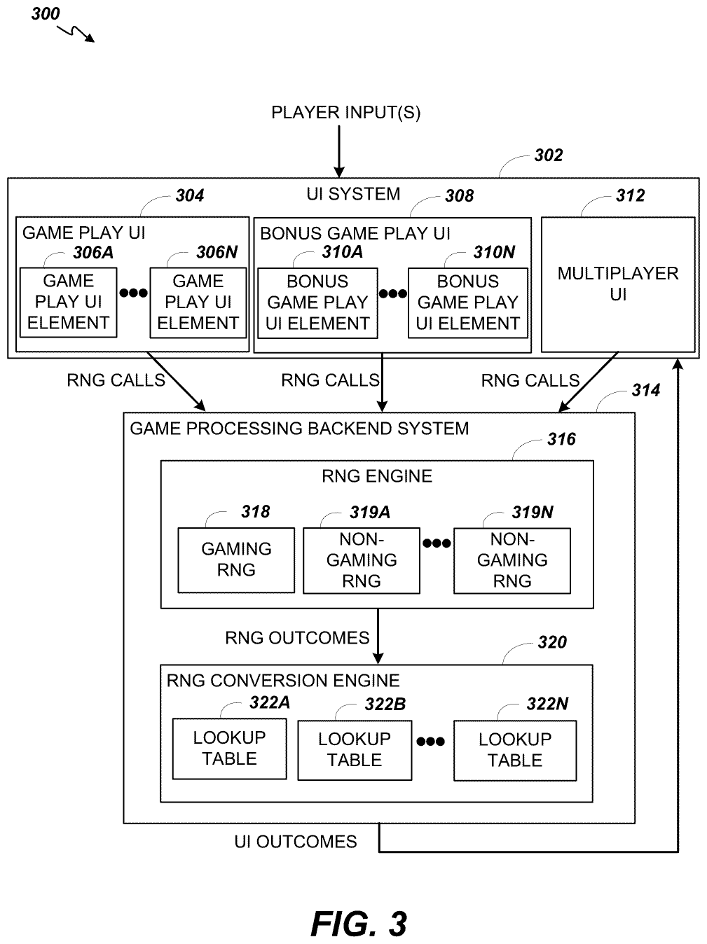

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

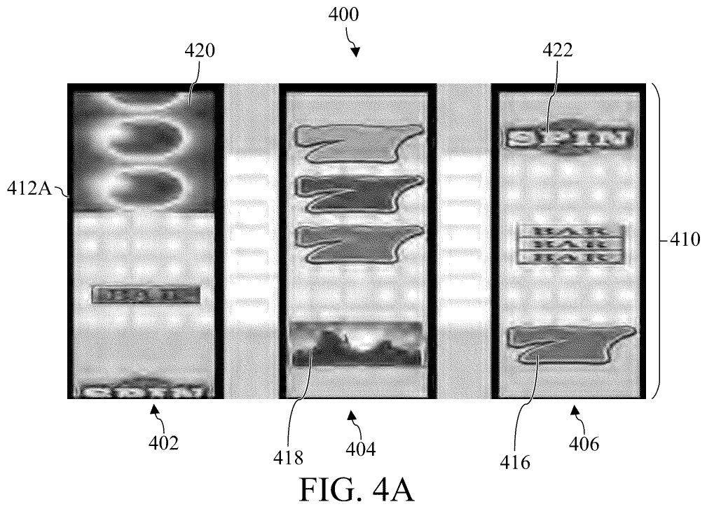

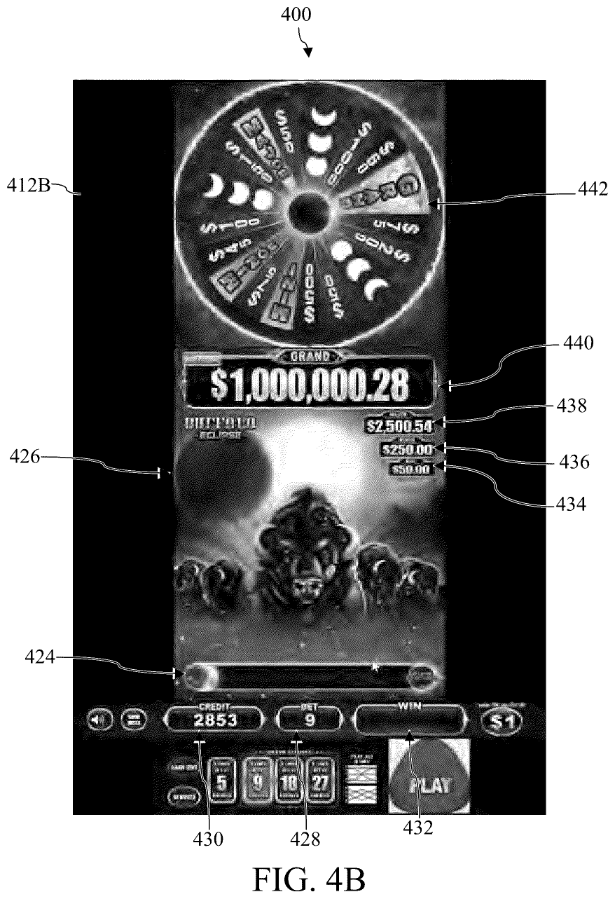

FIGS. 4A and 4B are example user interfaces, screenshots, and/or front views of an example base reel game 400 played on a gaming device (e.g., gaming devices 104A-104X in FIG. 1, and/or gaming device 200 and/or mobile gaming device 256 in FIG. 2B). Specifically, FIGS. 4A and 4B show base reel game 400, in which a base reel game outcome is displayed that corresponds to (e.g., presents, represents, and/or is determined from) an output of the gaming device. As discussed herein, FIG. 4A is an example user interface or front view of at least a portion of a first display device displaying or depicting a portion of base reel game 400, where FIG. 4B is an example user interface or screenshot of a second, distinct display device displaying or depicting a distinct portion of base reel game 400. The output may be a primary game outcome determined in response to a wager received from a player. In example implementations, the primary game outcome is a Class II (e.g., bingo) game outcome or a Class III or Las-Vegas style game outcome. In various implementations, the base reel game 400 may be implemented to present an outcome of any suitable game of chance. Specific details of the type of primary or base reel game outcomes presented using the base reel game 400 are not central to an understanding of the present disclosure. However, additional detail related to at least one implementation (e.g., an implementation employing the base reel game 400 to present a primary bingo-based or Class II game outcome) may be obtained with reference to U.S. Published Patent Application No. 2012/0270638, filed Apr. 20, 2011, and entitled GAMING MACHINE WITH FREE PLAY BONUS MODE PRESENTING ONLY WINNING OUTCOMES, the disclosure of which is hereby incorporated by reference herein in its entirety.

The base reel game 400 may be initiated on a gaming device 104A-104X, 200. For example, a player may fund the base reel game 400 via bill validator 234 and/or ticket reader 224. Once funded, the base reel game 400, which includes a first plurality of reels 402, 404, 406, each including a plurality of game symbols 410 that appear on a first display device 412A, as shown in FIG. 4A. In exemplary embodiments, the plurality of reels 402-406 are physical reels that are incorporated into and/or disposed within gaming device 104A-140X and are presented within first display device 412A. As used herein, physical reels are mechanical in nature and may be physically rotated during gameplay. In alternative embodiments, reels 402-406 are virtual reels that are rendered or visually created by game controller 202 on a display, such as display device 412A, and are merely animated to give the appearance of being spun. The plurality of reels 402-406 of the example base reel game 400 includes three (3) reels. In other examples, the number of reels may range from one reel to five or more reels in number. The base reel game 400 may be played on the physical or mechanical reels 402-406 included in first display device 412A, while additional bonus features and/or bonus games are played and/or displayed on a distinct or second display device 412B, as shown in FIG. 4B, and as discussed herein. However, in other implementations, the base reel game 400 and/or bonus features/games can be played on a single display device.

In the example shown in FIG. 4A, the base reel game 400 includes a first reel matrix on the primary display device 412A. The first reel matrix includes a plurality of symbol arrangements or positions arranged in a plurality of rows and a plurality of columns. The first reel matrix may also therefore be referred to as a “matrix of symbol positions” or “matrix of symbol arrangements.” While, in the example shown in FIG. 4A, the first reel matrix is displayed on first display device 412A, the first reel matrix may appear in other locations on an EGM 104A-104X and/or on other displays, such as, for example, the secondary display (e.g., display device 412B; FIG. 4B), a display of button deck 120, and the like. In the example embodiment shown in FIG. 4A, the plurality of reels 402-406 form three distinct reels and/or three columns. Each reel 402-406 also includes a number of rows as well. In the exemplary embodiment, reels 402-406 have approximately three (3) visible rows. As a result, the plurality of reels 402-406 for base reel game 400 include a 3×3×3 arrangement, as depicted on display device 412A, and include nine (9) game symbol positions. In other implementations, the plurality of reels 402-406 may be any size/uniformity/arrangement (e.g., 2×2, 3×3, 4×4, 10×10, etc.), and a number of game symbol positions for the plurality of reels 402-406 may vary depending upon a number of rows and columns of the plurality of reels 402-406.

As described herein, during play of the base reel game 400, game symbols 410 may be selected (e.g., such as from the plurality of reels 402-406) and displayed in the game symbol positions of each column and row of the plurality of reels 402-406. The game symbols 410 displayed after spinning and stopping each reel strip in a respective column of the plurality of reels 402-406 may be referred to herein as a “reel outcome” or a “base reel game outcome” or a “base game outcome.” More broadly, an “outcome” of a reel game, such as a base reel game (e.g., the base reel game 400) refers to the game symbols 410 displayed in the plurality of reels 402-406 after reel strips are spun and stopped. Thus, a rotation and stopping of a plurality of reel strips (also referred to herein as a “spin and stop sequence”) may be simulated by processor 204 within the columns of the plurality of reels 402-406 to cause a reel outcome, including a plurality of game symbols 410, to be displayed from the plurality of reel strips within the columns of the plurality of reels 402-406. Here again, however, mechanical reels having physical reel strips may be used as well.

As shown in the exemplary embodiment of FIG. 4A, and as discussed herein, the plurality of game symbols 410 included and/or displayed within the plurality of reels 402-406 include and/or are formed from various symbol types. For example, graphic game symbols 416 of the plurality of game symbols 410 include predetermined graphics, symbols, and/or art works that can be based on a theme, story, and/or visual representation of base reel game 400. Additionally, or alternatively, graphic game symbols include suitable graphics, symbols, and/or artworks commonly associated with a gaming device (e.g., “BAR,” “7,” “2×,” etc.). Collectively, these game symbols 410 are referred to herein as graphic symbols 416. The plurality of game symbols 410 can also include jackpot symbols (not shown), which include, display, depict, and/or are associated with jackpots, as discussed herein. That is, jackpot symbols can provide additional award credits to the player during base reel game 400.

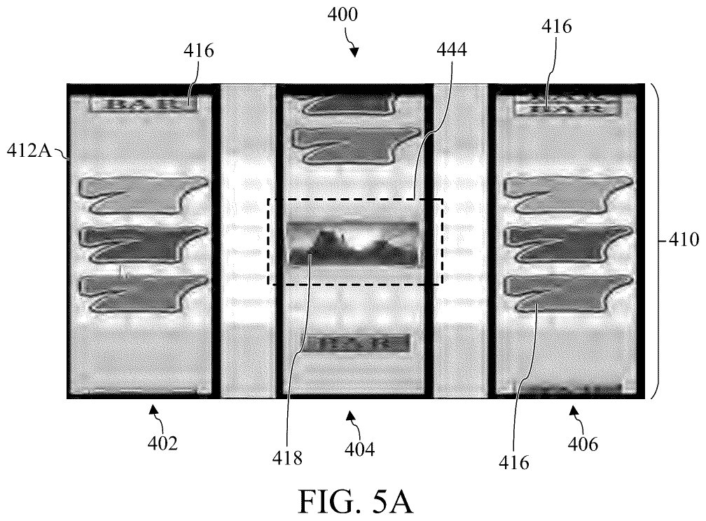

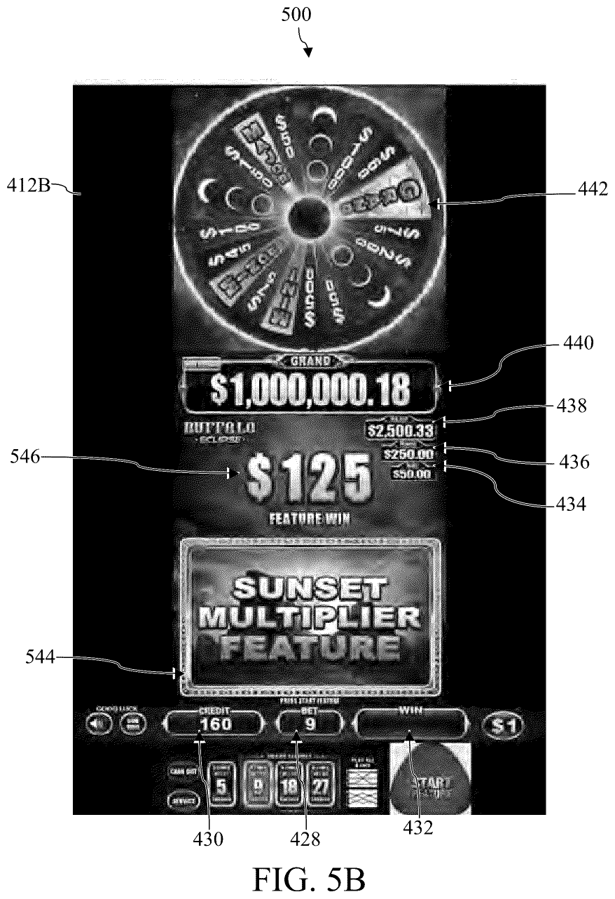

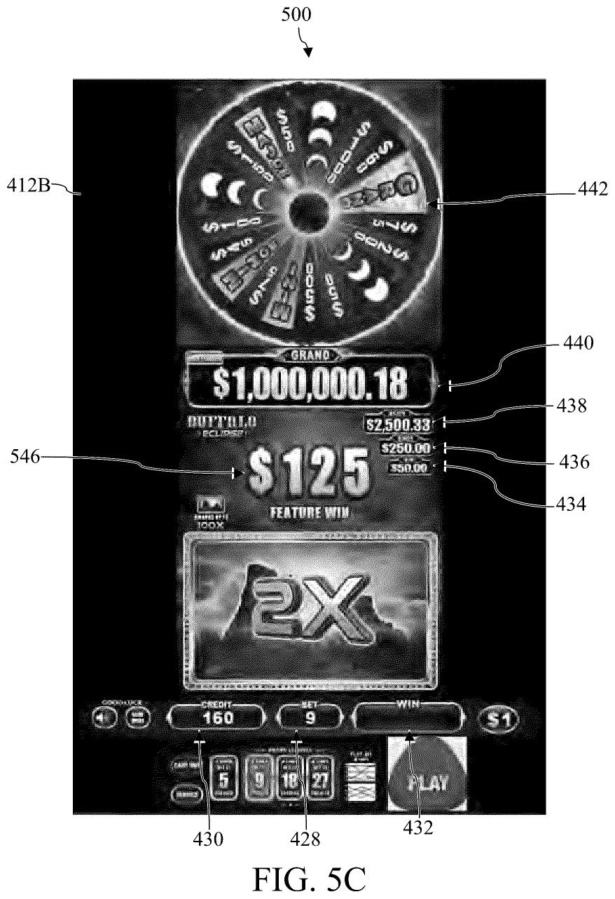

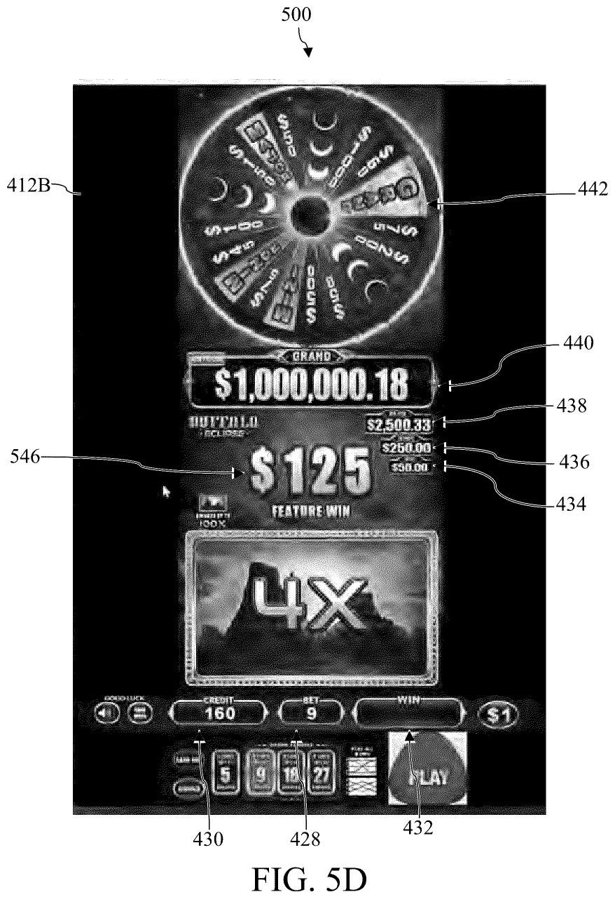

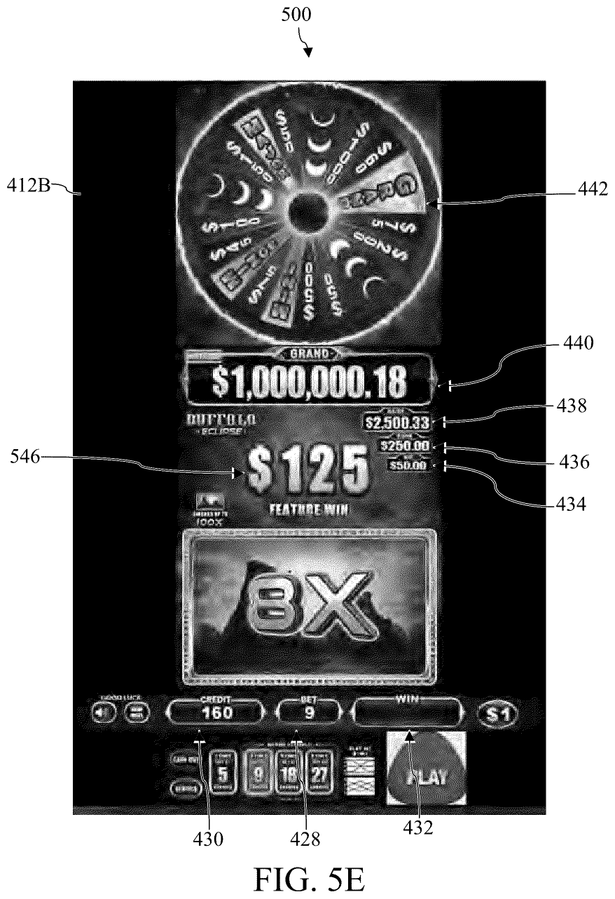

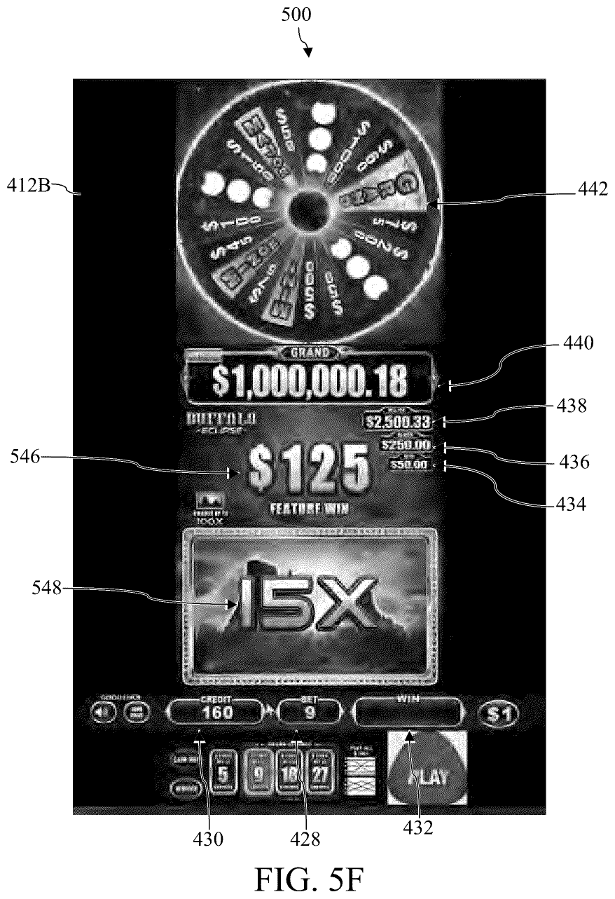

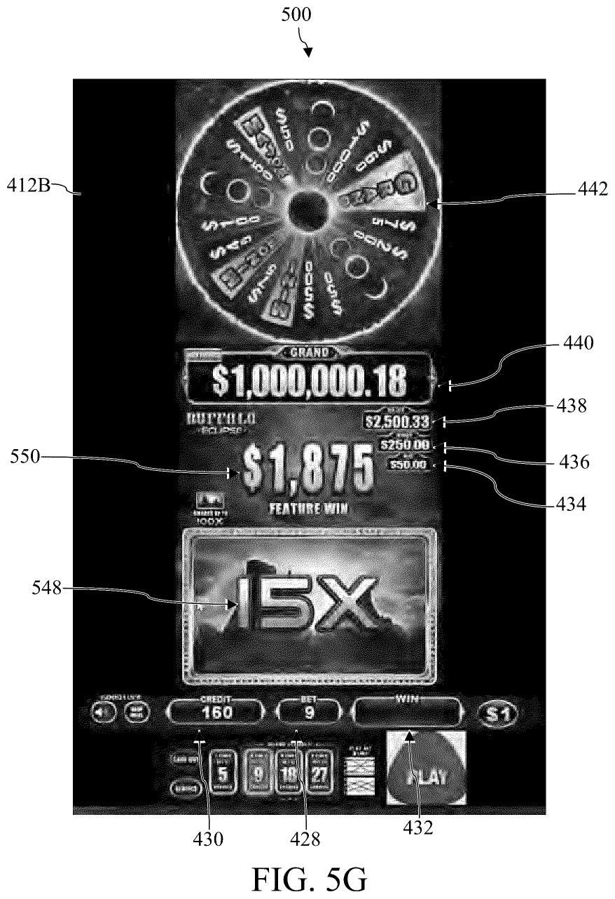

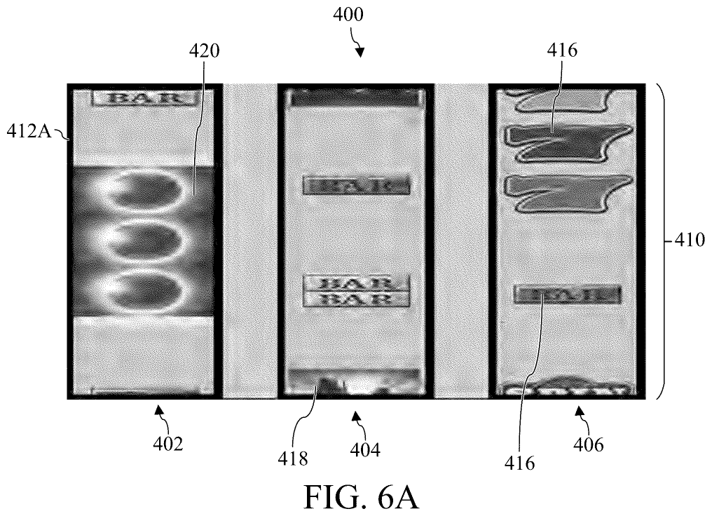

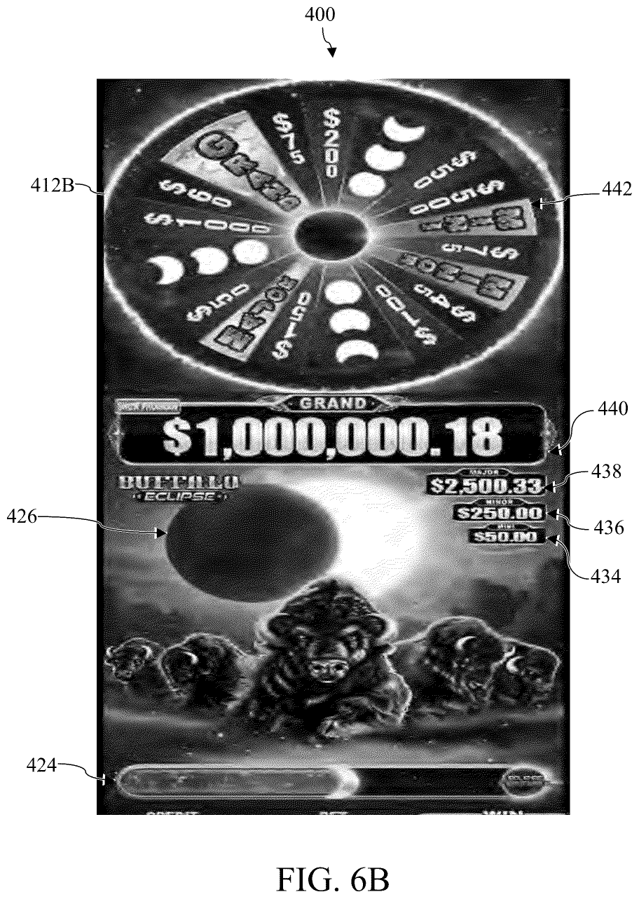

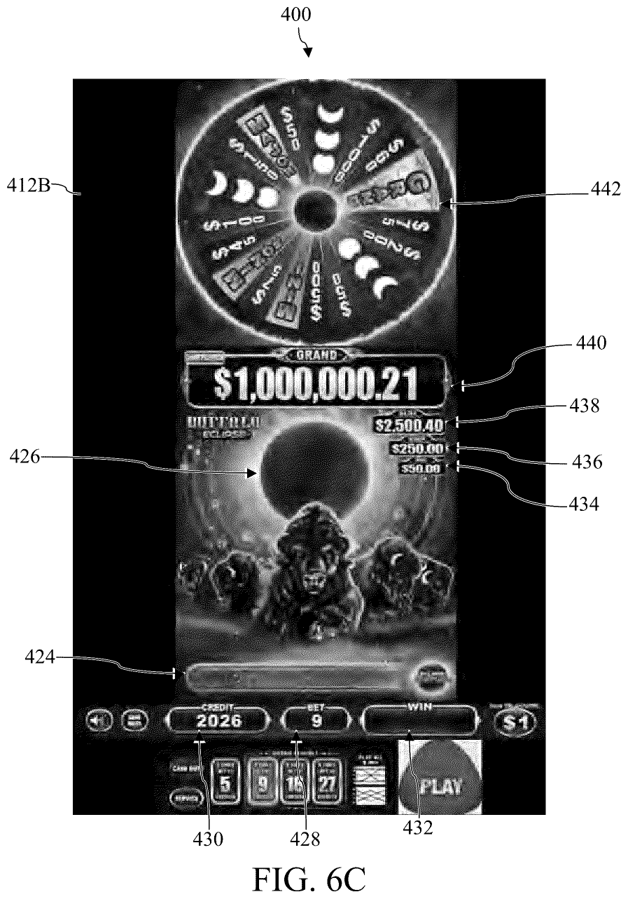

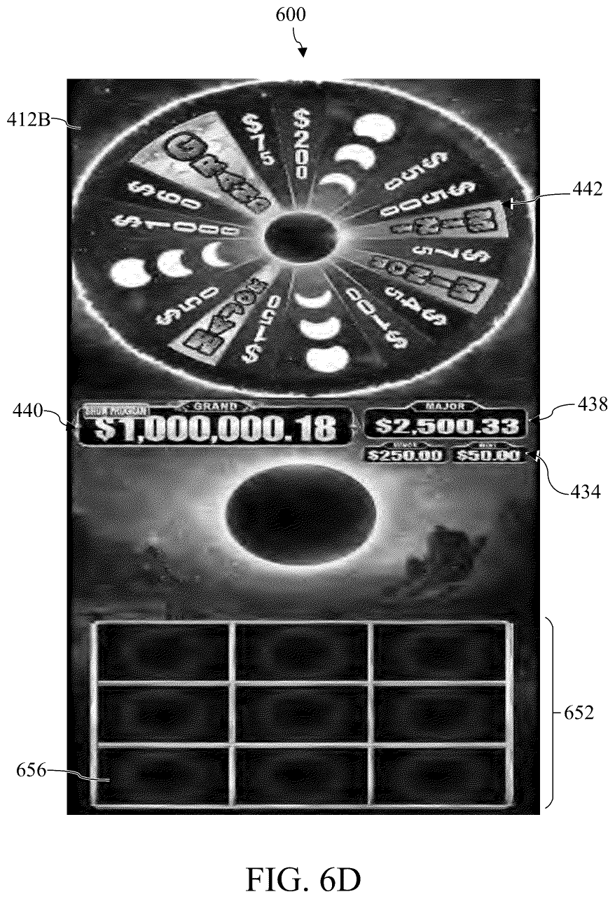

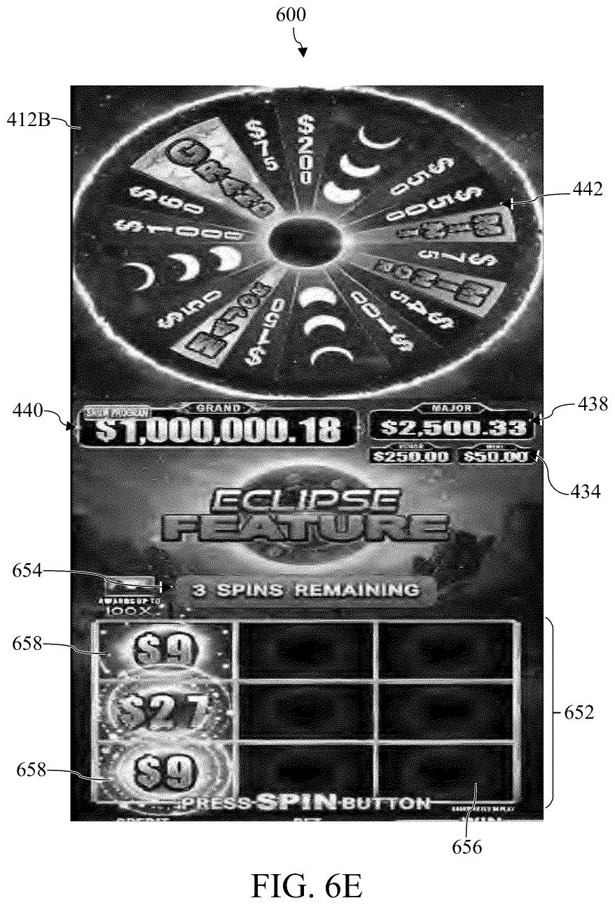

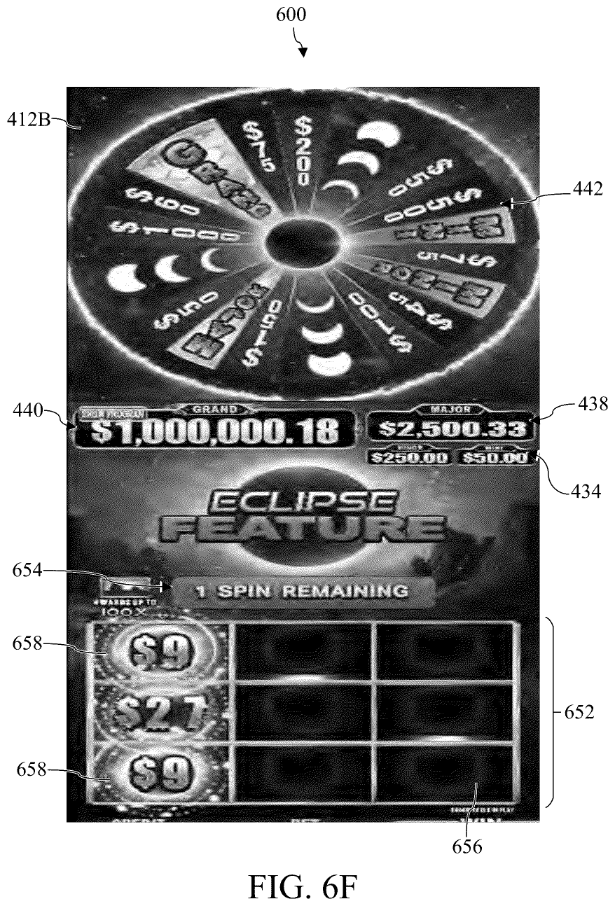

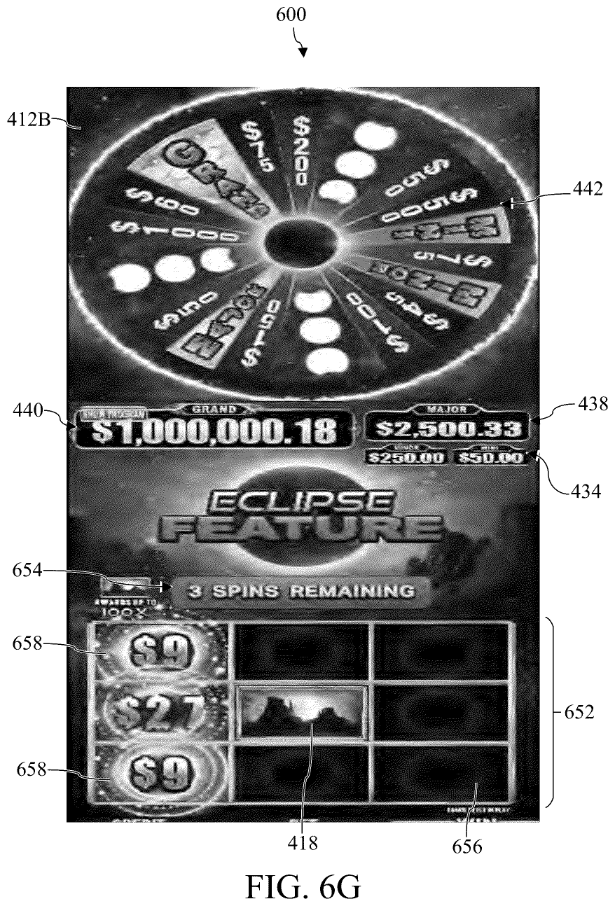

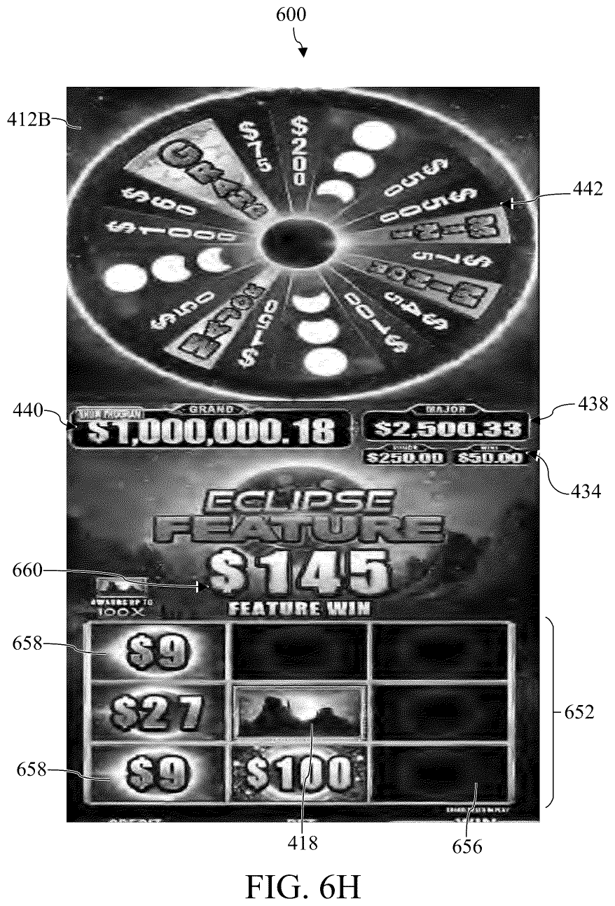

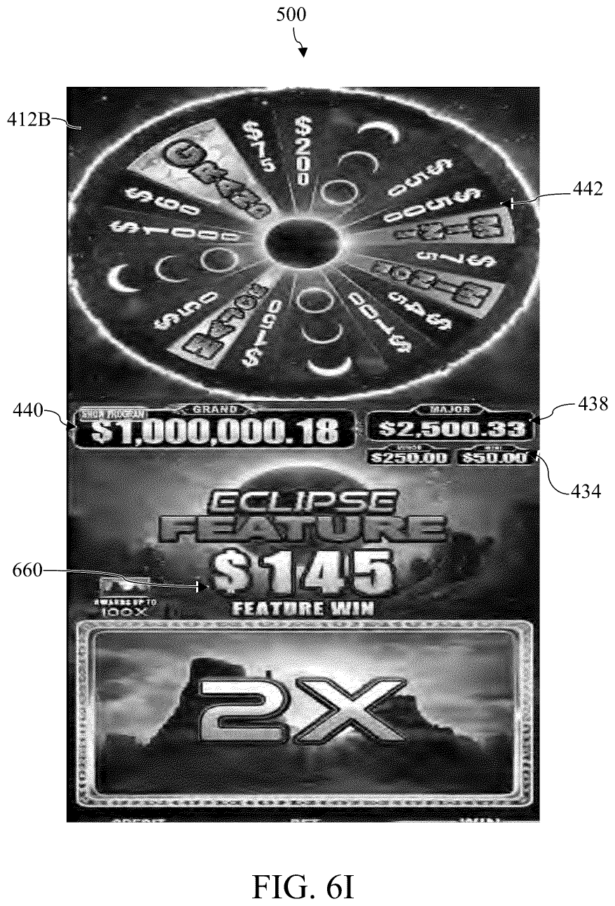

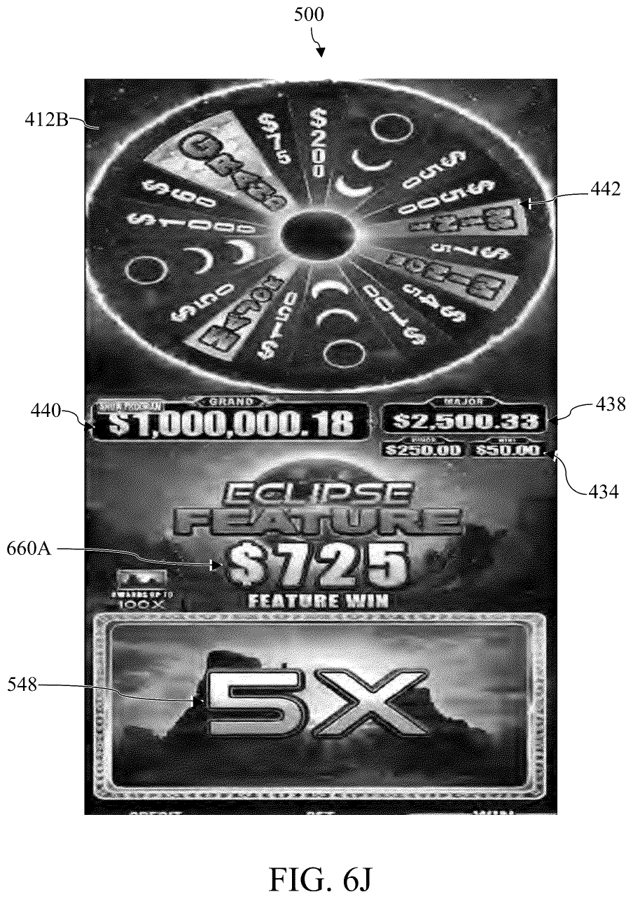

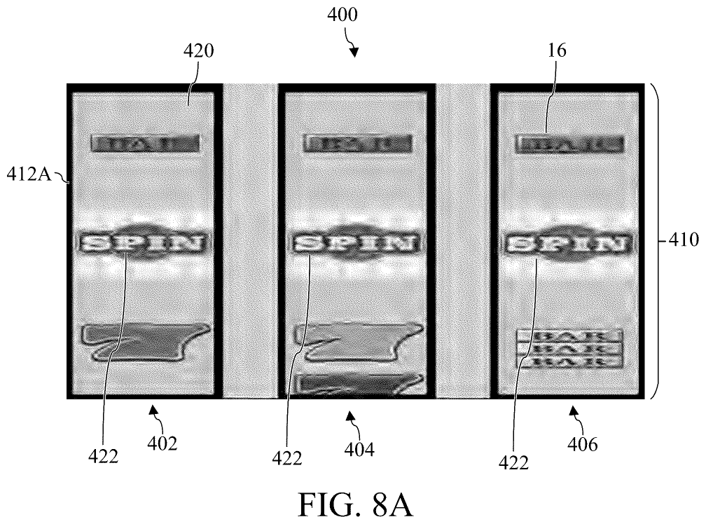

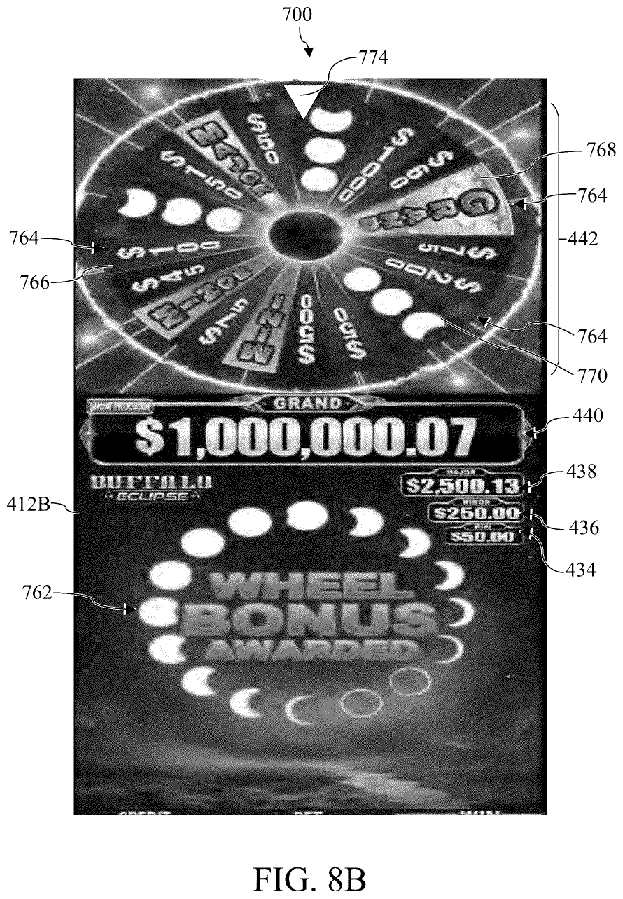

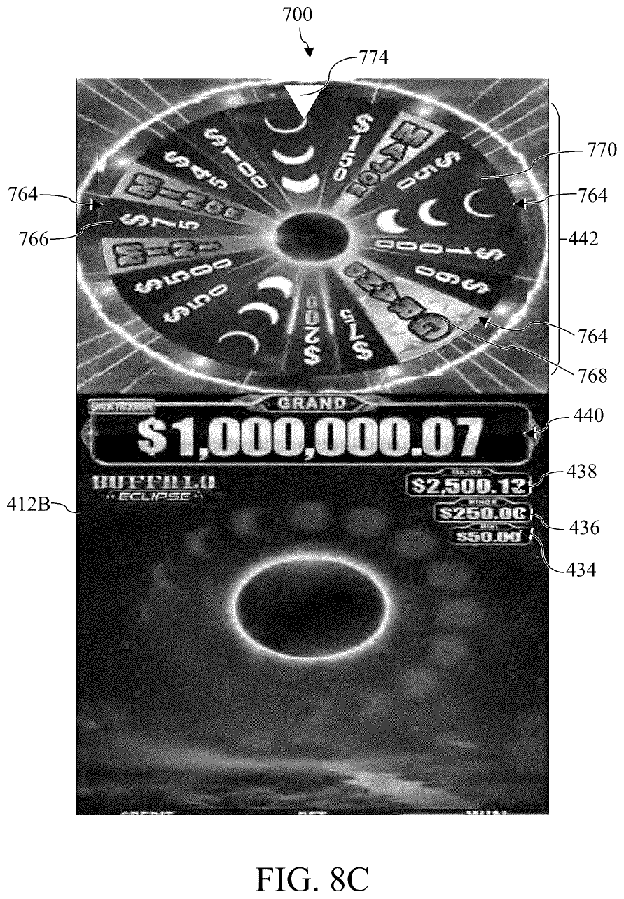

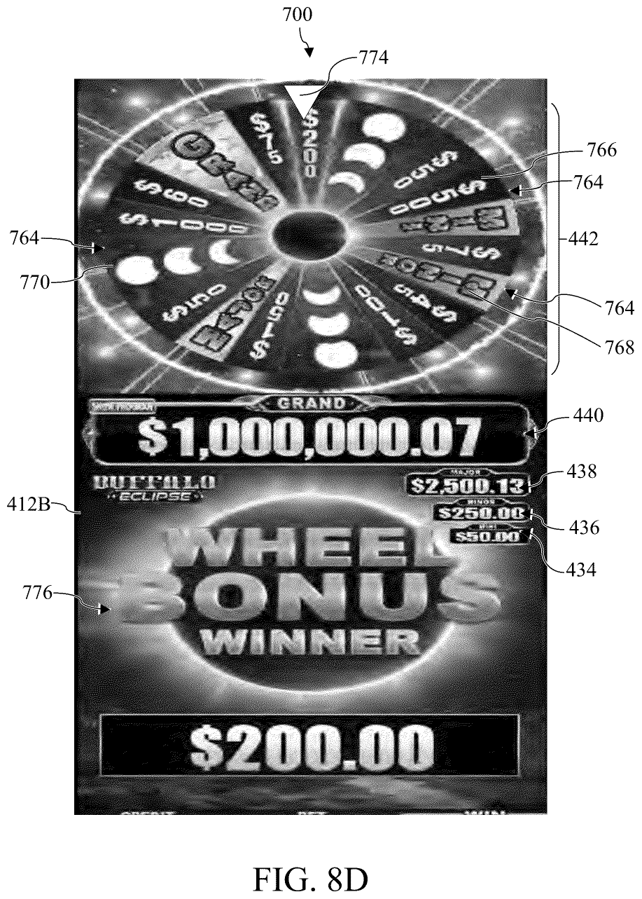

Furthermore, the plurality of game symbols 410 also include a plurality of feature symbols corresponding to and/or associated with bonus features and/or bonus games. For example, the plurality of game symbols 410 include at least one multiplier feature symbol 418 associated with and/or corresponding to a multiplier feature 500 (see, FIGS. 5A-5G), at least one hold-and-spin feature symbol 420 associated with and/or corresponding to a bonus hold-and-spin game 600 (see, FIGS. 6A-6J), and/or at least one wheel feature symbol 422 associated with and/or corresponding to a bonus wheel game 700 (see, FIGS. 8A-8D). As discussed herein, each of the plurality of feature symbols 418, 420, 422 are associated with and can trigger the occurrence and/or offering of associated bonus features and/or bonus games to the player of base reel game 400.

Turning to FIG. 4B, a portion of base reel game 400 is also depicted on distinct, display device 412B. As discussed herein, distinct display device 412B is positioned adjacent to (e.g., above) display device 412A including the plurality of physical or mechanical reels 402-406. The portion of base reel game 400 displayed on display device 412B includes a bonus indicator or meter 424 (hereafter, “bonus indicator 424”). Bonus indicator 424 provides a visual representation and/or illustration indicating how close a player is to triggering a bonus feature and/or game. More specifically, bonus indicator 424 includes a visual graphic displayed on display device 412B to dynamically indicate and/or represent to a player of base reel game 400 whether or not they are likely to trigger the bonus hold-and-spin game 600, as discussed herein. In exemplary embodiments shown in FIG. 4B, bonus indicator 424 includes a movable, metamorphic, animated, and/or fillable bar. As more triggering outcomes occur during base reel game 400, as discussed herein, the fillable bar of bonus indicator 424 moves from left to right to represent that a player is getting closer to triggering bonus hold-and-spin game 600. In the exemplary embodiment shown, the bar is in a left-most position of bonus indicator 424. As such, bonus indicator 424 of base reel game 400 shown in FIG. 4B indicates to the player that bonus hold-and-spin game 600 has not been triggered.

Although discussed herein including a fillable bar, it is to be understood that bonus indicator 424 can be formed and/or displayed as any suitable visual indicator including, but not limited to, a needle-gauge, animated letters (e.g., “BONUS”), or a metamorphic animation. For example, a distinct animation or visual graphic 426 positioned above bonus indicator 424 within display device 412B can also provide a visual representation and/or illustration indicating how close a player is to triggering a bonus feature and/or game. In exemplary embodiments, visual graphic 426 is based on a theme, story, and/or visual representation of base reel game 400 and can provide additional illustrations of how close a player is to triggering a bonus feature and/or game. As shown, and as discussed herein, visual graphic 426 includes an animated moon that progressively moves closer to and/or eclipses a sun, where a full eclipse of the animated sun by the moon would similarly indicate that a bonus feature and/or game has been triggered.

In operation, the reel outcome presented during play of the base reel game 400 (e.g., base reel game outcome) corresponds to, presents, represents, and/or is determined from a primary game outcome. For example, the reel outcome (base reel game outcome) may correspond to a primary or underlying Class II game, or the reel outcome may be determined randomly (e.g., in Class III games). Additionally, and as discussed herein, base reel game outcomes and/or conditions of base reel game 400 trigger the bonus features and/or bonus games. For example, and as discussed herein, a base reel game outcome displaying at least one hold-and-spin feature symbol 420 within the plurality of reels 402-406 can trigger the bonus hold-and-spin game 600.

As shown in FIG. 4B, base reel game 400 also includes a wager meter 428, and a credit meter 430 depicted on display device 412B. Wager meter 428 represents and/or displays the credit and/or monetary value being wagered during each play of base reel game 400, as determined by the player. Credit meter 430 displays a credit balance (calculated as a sum total of credits input and awards accrued minus wagers placed) accrued until a player cashes out. As shown in FIG. 4B, a win meter 432 is also displayed in base reel game 400. As discussed herein, win meter 432 displays a credit and/or monetary value awarded during outcomes of the base reel game 400, bonus feature 500, and/or bonus games 600, 700, as discussed herein.

In exemplary embodiments, base reel game 400 also displays a plurality of “jackpot” bonuses 434-440 on display device 412B. For example, jackpot bonus 434 includes a “mini” jackpot value, jackpot bonus 436 includes a “minor” jackpot value, jackpot bonus 438 includes a “major” jackpot value, and jackpot bonus 440 includes a “grand” jackpot value. As discussed herein, each jackpot bonus 434-440 correspond to and/or is correlated with at least one jackpot symbol displayed in the base reel game outcome of base reel game 400 and/or bonus game outcome for bonus wheel game 700. Additionally, the credit value associated with each jackpot bonus 434-440 may be a predetermined credit value. Alternatively, jackpot bonuses 434-440 may include progressive credit values that are dependent upon, at least in part, the credit and/or monetary value being wagered during each play of base reel game 400 (e.g., wager meter 428), the number of consecutive base reel games 400 played prior to triggering bonus wheel game 700, and the like.

Display device 412B depicting base reel game 400 also includes a bonus wheel 442. As discussed herein, bonus wheel 442 is utilized, interacted with, and/or displayed during bonus wheel game 700 (see, FIGS. 8A-8D). Bonus wheel 442 spins and/or provides free spin(s) during the bonus wheel game 700 and awards the user of gaming device 104 increased prizes and/or credits, as discussed herein.

FIGS. 5A-5G are exemplary user interfaces or screenshots after the triggering of multiplier feature 500. More specifically, FIG. 5A is an exemplary user interface or view of first display device 412A depicting a base reel game outcome that triggers multiplier feature 500. In exemplary embodiments multiplier feature 500 is triggered as a result of base reel game outcome including, depicting, and/or displaying at least one multiplier feature symbol 418 in a predefined symbol position for the plurality of reels 402-406 of base reel game 400. As shown in FIG. 5A, multiplier feature symbol 418 positioned and/or displayed in the middle of mechanical reel 404 (e.g., predefined symbol position 444) of the plurality of reels 402-406 during base reel game 400 triggers multiplier feature 500 on display device 412B (see, FIGS. 5B-5G). In other exemplary embodiments, the depicting of multiplier feature symbol 418 anywhere in the base reel game outcome can trigger multiplier feature 500, regardless of what symbol position and/or which mechanical reel 402-406 multiplier feature symbol 418 is displayed in.

Referring to FIGS. 5B-5G, exemplary user interfaces or screenshots of a sequence of multiplier feature 500 initiated after playing base reel game 400 (see, FIG. 5A) are displayed. Specifically, FIGS. 5B-5G are exemplary user interfaces or screenshots after multiplier feature symbol 418 is displayed in the outcome of base reel game 400 (see, FIG. 5A), and distinct, second display device 412B initiates the displaying and/or presenting of multiplier feature 500 to the player. In exemplary embodiments, when multiplier feature 500 is triggered during base reel game 400, the gameplay on gaming device 104 shifts or moves from the first display device 412A including the mechanical reels 402-406 to the second display device 412B (e.g., digital monitor). Second display device 412B allows a player or user the opportunity to play multiplier feature 500 independent from first display device 412A and/or the plurality of mechanical reels 402-406 used to play base reel game 400. A notification 544 is presented to the player on display device 412B to indicate and/or represent that multiplier feature 500 has been triggered. Additionally as shown in FIG. 5B, an initial payline credit value 546 is presented to the player on display device 412B. Initial payline credit value 546 is based on the base reel game outcome for base reel game 400. More specifically, initial payline credit value 546 includes and/or corresponds to a winning credit value that is awarded to the player based on the base reel game outcome and/or the configuration or payline of game symbols 410 included on reels 402-406 during base reel game 400.

FIGS. 5C-5F are exemplary user interfaces or screenshots of a sequence of the gameplay of multiplier feature 500. That is, and as shown in FIGS. 5C-5F, subsequent to displaying notification 544 and initial payline credit value 546 on display device 412B, the gameplay or visual presentation of multiplier feature 500 continues by defining a multiplier value 548 (see, FIG. 5F) for triggered, multiplier feature 500. As shown in FIGS. 5C-5F, various multiplier values, increasing in value, can be presented to the player on display device 412B until a final, multiplier value 548 is presented and/or displayed during multiplier feature 500. For example, display device 412B can initially present a “2×” multiplier value (see, FIG. 5C), and subsequently present, in order, a “4×” multiplier value (see, FIG. 5D), an “8×” multiplier value (see, FIG. 5E), before randomly determining and displaying final, multiplier value 548 of a “15×” multiplier value (see, FIG. 5F). It is to be understood that multiplier feature 500 can include any predetermined value multiplier values (e.g., 2×, 4×, 5× 8×, 10×, 20×, etc.) during multiplier feature 500, and/or can present multiplier values in a sequential order as shown herein, or alternatively can present multiplier values in random order. In exemplary embodiments, and as shown in FIGS. 5B-5F, multiplier value 548 includes an upper threshold of “100×.” However, it is understood that the threshold for multiplier value 548 of multiplier feature 500 can be more or less than “100×.”

Display device 412B can provide a unique animation and/or EGM 104 can provide additional output (e.g., sounds) to indicate to a player that the final multiplier value 548 is equal to “15×” for multiplier feature 500. After being determined, defined, and/or finalized, multiplier value 548 defines a final or multiplier feature credit value 550 for multiplier feature 500. That is, the value for multiplier value 548 (e.g., “15×”) can subsequently multiply the initial payline credit value 546 (see, FIG. 5B) to define or determine multiplier feature credit value 550. In the exemplary embodiment shown in FIG. 5G, multiplier value 548 included within multiplier feature 500 includes a predetermined multiplying factor of fifteen (15) (“15×”). As a result, initial payline credit value 546 (e.g., “$125”) is multiplied by a factor of 15, to define and/or determine multiplier feature credit value 550 as “$1,875.” Multiplier feature credit value 550 determined during multiplier feature 500, and as displayed on display device 412B, is subsequently added to win meter 432, and multiplier feature 500 ends. As a result of ending multiplier feature 500, display device 412B reverts back to base reel game 400 (see, FIG. 4B).

FIGS. 6A-6H are exemplary user interfaces, screenshots and/or front views of display devices 412A, 412B after the triggering of bonus hold-and-spin game 600. More specifically, FIG. 6A is an exemplary user interface or view of first display device 412A depicting a base reel game outcome that triggers bonus hold-and-spin game 600. In exemplary embodiments bonus hold-and-spin game 600 is triggered as a result of base reel game outcome including, depicting, and/or displaying at least one hold-and-spin feature symbol 420 in the plurality of reels 402-406 of base reel game 400. As shown in FIG. 6A, hold-and-spin feature symbol 420 positioned and/or displayed in reel 402 of the plurality of mechanical reels 402-406 during base reel game 400 triggers bonus hold-and-spin feature 600 on display device 412B (see, FIGS. 6B-6H).

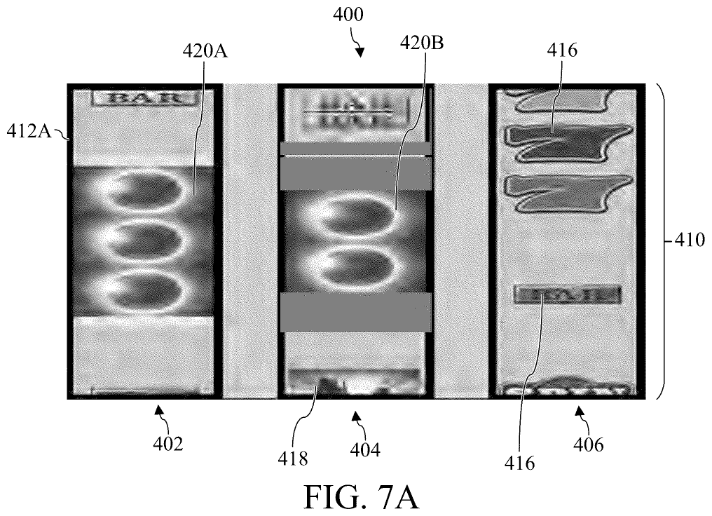

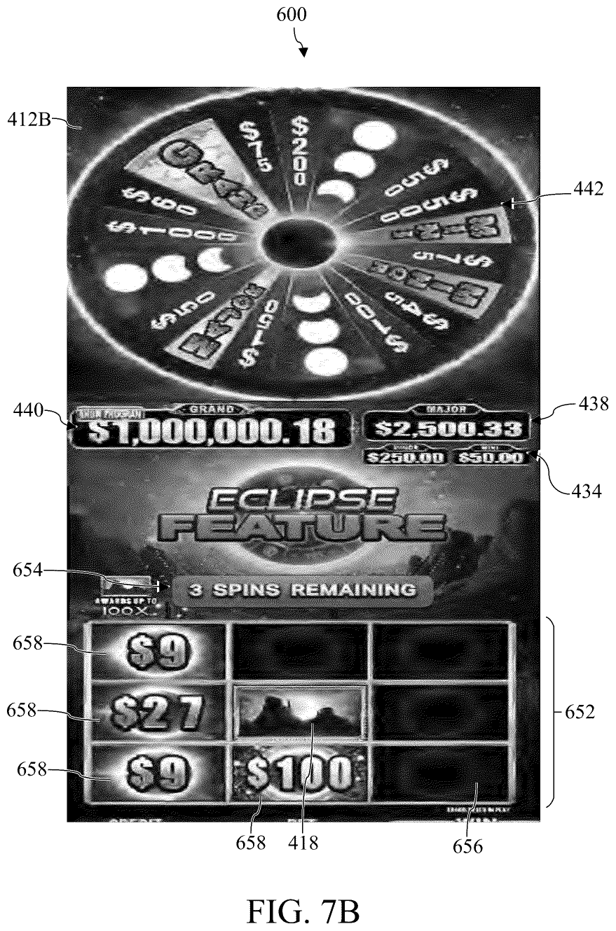

As shown in FIG. 6A, hold-and-spin feature symbol 420 depicted in mechanical reel 402 includes three (3) eclipse graphics. In addition to each reel 402-406 including hold-and-spin feature symbol(s) 420, each reel 402-406 included in first display device 412A also includes a plurality of hold-and-spin feature symbols 420. Each hold-and-spin feature symbol 420 included in each of the plurality of reels 402-406 include a varying number of eclipse graphics. For example, each reel 402-406 can include three (3) distinct hold-and-spin feature symbols 420, where a first hold-and-spin feature symbol 420 includes three (3) eclipse graphics, a second hold-and-spin feature symbol 420 includes two (2) eclipse graphics (see, FIG. 7A), and a third hold-and-spin feature symbol 420 includes once (1) eclipse graphic (not shown). As discussed herein, and in addition to triggering bonus hold-and-spin game 600, hold-and-spin feature symbol(s) 420 displayed in the base reel game outcome also define pre-populated symbols within the hold-and-spin reel for bonus hold-and-spin game 600.

Referring to FIGS. 6B-6H, exemplary user interfaces or screenshots of a sequence of bonus hold-and-spin game 600 initiated after playing base reel game 400 (see, FIG. 6A) are displayed. Specifically, FIGS. 6B-6H are exemplary user interfaces or screenshots after hold-and-spin feature symbol 420 is displayed in the outcome of base reel game 400 (see, FIG. 6A), and distinct display device 412B initiates the displaying and/or presenting of bonus hold-and-spin game 600 to the player. FIGS. 6B and 6C depict bonus indicator 424 transitioning from partially filled bar (see, FIG. 6B) to completely filled bar (see, FIG. 6C). That is, and in response to triggering bonus hold-and-spin game 600, the fillable bar of bonus indicator 424 can transition, be animated, metamorphosize, and/or “fill” to indicate and/or represent that bonus hold-and-spin game 600 has been triggered. Additionally, and to provide further visual representation, visual graphic 426 displayed on display device 412B is also animated, transitioned, and/or metamorphosized to provide an indication that bonus hold-and-spin game 600 is triggered (e.g., moon graphic eclipses sun).

In exemplary embodiments, the increments in which the fillable bar of bonus indicator 424 is filled during base reel game 400 is dependent, at least in part, upon the number of hold-and-spin feature symbol(s) 420 displayed in mechanical reels 402-406 during base reel game 400. For example, each instance in which hold-and-spin feature symbol 420 is displayed or included within the base reel game outcome for base reel game 400, the fillable bar may be filled by a single, predetermined increment or segment. Additionally, or alternatively, the number of eclipse graphics included in the displayed hold-and-spin feature symbol 420 can determine the number of increments or segments in which the fillable bar of bonus indicator 424 is filled during base reel game 400. In exemplary embodiments, hold-and-spin feature symbol 420 depicting three (3) eclipse graphics can increase or add to the fillable bar by three (3) predetermined increments or segments, while hold-and-spin feature symbol 420 depicting one (1) eclipse graphic increases or adds to the fillable bar by a single (1) predetermined increment or segment. In other exemplary embodiments, fillable bar of bonus indicator 424 may be filled at random, as the triggering of bonus hold-and-spin game 600 is random and only dependent upon the displaying of at least one hold-and-spin feature symbol 420 within the base reel game outcome.

Additionally, or alternatively, when the base reel game outcome for base reel game 400 includes a predetermined number of hold-and-spin feature symbol 420 in a single base reel game outcome, bonus hold-and-spin game 600 may be triggered. In an exemplary embodiment, where each reel 402-406 displays hold-and-spin feature symbol 420 in a single base reel game outcome, bonus hold-and-spin game 600 is instantly triggered. Moreover, the triggering of bonus hold-and-spin game 600 is dependent, at least in part, on the number of eclipse graphics included in the hold-and-spin feature symbol(s) 420 displayed in the base reel game outcome. For example, where four (4) or more eclipse graphics are displayed in a single base reel game outcome, bonus hold-and-spin game 600 is instantly triggered. That is, if reel 402 displays hold-and-spin feature symbol 420 includes two (2) eclipse graphics, and each of reel 404 and reel 406 display hold-and-spin feature symbol 420 include one (1) eclipse graphic, the fillable bar included in bonus indicator 424 is filled and bonus hold-and-spin game 600 is triggered on second display device 412B.

Referring to FIGS. 6D-6H, exemplary user interfaces or screenshots of a sequence of the gameplay of bonus hold-and-spin game 600 initiated after playing base reel game 400 (see, FIG. 6A) are displayed. In exemplary embodiments, bonus hold-and-spin game 600 includes a plurality of hold-and-spin reels 652. Prior to “spinning” the plurality of reels 652, a spin number indicator 654 (see, FIG. 6E) can display and/or present a predetermined number of bonus spins for bonus hold-and-spin game 600. In exemplary embodiments, the predetermined number of bonus spins for bonus hold-and-spin game 600 is three (3). The user or player of bonus hold-and-spin game 600 “spins” the plurality of reels 652 to attempt to display hold-and-spin symbols (e.g., COR symbols, multiplier feature symbol 418) thereon, as discussed herein. Each spin in which one or more symbol lands or is displayed on at least one reel 652 of bonus hold-and-spin game 600, the spin number indicator 654 is reset back to the predetermined number of spins for bonus hold-and-spin game 600. In another non-limiting example, the number of spins are not reset in response to displaying symbols during bonus hold-and-spin game 600. Rather, the player can spin hold-and-spin reels 652 the predetermined number of spins (e.g., three spins), before bonus hold-and-spin game 600 ends.

In exemplary embodiments, the plurality of hold-and-spin reels 652 can display and/or include a blank symbol 656. As shown in FIG. 6D, blank symbol 656 can be included and/or displayed within each bonus game symbol position (e.g., rows and columns) for the plurality of reels 652 for bonus hold-and-spin game 600. Blank symbols 656 of the bonus symbols do not include, display, and/or present any credit value that are awarded to the player during bonus hold-and-spin game 600. Additionally, the plurality of hold-and-spin reels 652 can display and/or include cash-on-reel (COR) symbols 658 (see, FIG. 6E) thereon. COR symbols 658 include, display, depict, and/or are associated with a predetermined credit value (e.g., COR credit value) that can provide additional award credits during bonus hold-and-spin game 600, as discussed herein. The plurality of hold-and-spin reels 652 of bonus hold-and-spin game 600 can also include and/or depict multiplier feature symbol 418 (see, FIG. 6H).

FIG. 6E is an exemplary user interface or screenshot of an outcome of bonus hold-and-spin game 600. That is, FIG. 6E is an exemplary embodiment after the player has spun the plurality of reels 652 of bonus hold-and-spin game 600 depicted on display device 412B at least once. As shown, the plurality of reels 652 display a plurality of COR symbols 658 thereon.

Alternatively, FIG. 6E is an exemplary user interface or screenshot of bonus hold-and-spin game 600 prior to the first spin of the plurality of reels 652. As discussed herein, hold-and-spin feature symbol(s) 420 displayed in the base reel game outcome also define pre-populated symbols within the hold-and-spin reels 652 for bonus hold-and-spin game 600. For example, the number of eclipse graphics included in hold-and-spin feature symbol(s) 420 and displayed in the base reel game outcome that triggers bonus hold-and-spin game 600 determines the number of reels 652 that are pre-populated during bonus hold-and-spin game 600. Briefly returning to FIG. 6A, hold-and-spin feature symbol 420 displayed in reel 402 includes three (3) eclipse graphics. As such, and prior to the initial or first spin of bonus hold-and-spin game 600, three (3) reels of the plurality of (e.g., nine (9)) hold-and-spin reels 652 are pre-populated and/or include COR symbols 658. In exemplary embodiments, the position of pre-populated hold-and-spin reels 652 within bonus hold-and-spin game 600 are random, or alternatively correspond to hold-and-spin feature symbol 420 displayed in the base reel game outcome. For example, where hold-and-spin feature symbol 420 includes three (3) eclipse graphics displayed in first reel 402, a first column of the plurality of hold-and-spin reels 652 are pre-populated with COR symbols 658.

FIG. 6F is an exemplary embodiment after the player has performed additional spins of the plurality of reels 652 during the game play of bonus hold-and-spin game 600. In the non-limiting examples, no additional or new COR symbols 658 are displayed and/or included within the plurality of hold-and-spin reels 652 (see, FIG. 6E). As a result, the number of spins included in spin number indicator 654 have been reduced from three (3). Specifically, spin number indicator 654 includes “1 spin remaining” as a result of the player performing two previous spins during bonus hold-and-spin game 600 that did not result in the displaying of additional COR symbols 658 and/or multiplier feature symbol 418 within the plurality of hold-and-spin reels 652.

FIG. 6G is an exemplary embodiment after the player has performed further spins of the plurality of reels 652 during the game play of bonus hold-and-spin game 600. As shown, the plurality of hold-and-spin reels 652 for bonus hold-and-spin game 600 include multiplier feature symbol 418. As discussed herein (see, FIGS. 6I and 6J), displaying multiplier feature symbol 418 on the plurality of hold-and-spin reels 652 during bonus hold-and-spin game 600 can trigger multiplier feature 500 involving credit values associated with the bonus hold-and-spin outcome for bonus hold-and-spin game 600.

FIG. 6H is an exemplary user interface or screenshot of a final outcome of bonus hold-and-spin game 600. That is, FIG. 6H is an exemplary user interface or screenshot depicting the plurality of hold-and-spin reels 652 and all associated symbols included thereon after all bonus spins of the plurality of hold-and-spin reels 652 have been taken and/or bonus hold-and-spin game 600 has ended. In the exemplary embodiment, the credit values corresponding to and/or included with all displayed COR symbols 658 are added to define a hold-and-spin credit value 660. As shown in FIG. 6H, the hold-and-spin credit value 660 for bonus hold-and-spin game 600 is equal to “$145” (e.g., $9+$27+$9+$100=$145). In an exemplary embodiment where multiplier feature symbol 418 is not displayed in the plurality of hold-and-spin reels 652 during bonus hold-and-spin game 600, hold-and-spin credit value 660 is added to win meter 432, and bonus hold-and-spin game 600 ends. As a result of ending, display device 412B reverts back to base reel game 400 (see, FIG. 4B).

However, in the exemplary embodiment shown, the plurality of hold-and-spin reels 652 display multiplier feature symbol 418 during bonus hold-and-spin game 600. As a result, multiplier feature 500 is subsequently triggered from the outcome of bonus hold-and-spin game 600. Referring to FIGS. 6I and 6J, exemplary user interfaces or screenshots of a sequence of multiplier feature 500 initiated by bonus hold-and-spin game 600 (see, FIG. 6H) are displayed. Specifically, FIGS. 6I and 6J are exemplary user interfaces or screenshots after multiplier feature symbol 418 is displayed in the outcome of bonus hold-and-spin game 600, and distinct display device 412B initiates the displaying and/or presenting of multiplier feature 500 to the player. In exemplary embodiments, hold-and-spin credit value 660 is presented to the player on display device 412B. As discussed herein, the credit values corresponding to and/or included with all COR symbols 658 displayed during bonus hold-and-spin game 600 are added or totaled to define hold-and-spin credit value 660.

As shown in FIGS. 6I and 6J, various multiplier values, increasing in value, can be presented to the player on display device 412B until a final, multiplier value 548 (see, FIG. 6J) is presented and/or displayed during multiplier feature 500. For example, display device 412B can initially present a “2×” multiplier value (see, FIG. 6I), and subsequently present various multiplier values (e.g., “3×,” “4×”), before displaying final, multiplier value 548 of “5×” see, FIG. 6J). As similarly discussed herein, multiplier feature 500 can include any predetermined value multiplier values (e.g., 2×, 4×, 5× 8×, 10×, 20×, etc.) during multiplier feature 500. Additionally, multiplier values can be presented in a sequential order as shown herein, or alternatively can be presented in a random order during multiplier feature 500. Additionally, and as shown in FIGS. 6I and 6J, multiplier value 548 includes an upper threshold of “100×.” However, it is understood that the threshold for multiplier value 548 of multiplier feature 500 can be more or less than “100×.”

Display device 412B can provide a unique animation and/or EGM 104 can provide additional output (e.g., sounds) to indicate to a player that the final multiplier value 548 is equal to “5×” for multiplier feature 500. After being determined, defined, and/or finalized, multiplier value 548 defines a final hold-and-spin credit value 660 for multiplier feature 500. That is, the value for multiplier value 548 (e.g., “5×”) can be multiplied by hold-and-spin credit value 660 (see, FIG. 6I), as determined during bonus hold-and-spin game 600 (see, FIGS. 6D-6H), to define a final hold-and-spin credit value 660A. In the exemplary embodiment shown in FIG. 6J, multiplier value 548 of multiplier feature 500 includes a predetermined multiplying factor of five (5) (“5×”). As a result, hold-and-spin credit value 660 (e.g., “$145”) is multiplied by a factor of 5, to define and/or determine final hold-and-spin credit value 660A is “$725.” In the exemplary embodiment, final hold-and-spin credit value 660A determined during multiplier feature 500, and as displayed on display device 412B, is subsequently added to win meter 432, and multiplier feature 500 ends. As a result of ending, display device 412B reverts back to base reel game 400 (see, FIG. 4B).

FIG. 7A is an exemplary user interface or view of first display device 412A depicting a base reel game outcome that triggers bonus hold-and-spin game 600. In exemplary embodiments bonus hold-and-spin game 600 is triggered as a result of base reel game outcome including, depicting, and/or displaying at least one hold-and-spin feature symbol 420 in the plurality of reels 402-406 of base reel game 400. As shown in FIG. 7A, hold-and-spin feature symbol 420A positioned and/or displayed in reel 402 and hold-and-spin feature symbol 420B positioned and/or displayed in reel 404 during base reel game 400 triggers bonus hold-and-spin feature 600 on display device 412B (see, FIG. 7B). In the non-limiting example, hold-and-spin feature symbol 420A displayed in reel 402 includes three (3) eclipse graphics, while hold-and-spin feature symbol 420B displayed in reel 404 include two (2) eclipse graphics.

FIG. 7B is an exemplary user interface or screenshot of bonus hold-and-spin game 600 prior to the first spin of the plurality of reels 652. As discussed herein, hold-and-spin feature symbol(s) 420 displayed in the base reel game outcome also define pre-populated symbols within the hold-and-spin reels 652 for bonus hold-and-spin game 600. For example, the number of eclipse graphics included in hold-and-spin feature symbol(s) 420A, 420B and displayed in the base reel game outcome that triggers bonus hold-and-spin game 600 determine the number of reels 652 that are pre-populated during bonus hold-and-spin game 600. In exemplary embodiments, and with continued reference to FIG. 7A, hold-and-spin feature symbol 420A includes three (3) eclipse graphics and is displayed in first reel 402, and hold-and-spin feature symbol 420B displayed in reel 404 include two (2) eclipse graphics. As such, each of the three (3) hold-and-spin reels 652 in the first column of bonus hold-and-spin game 600 are pre-populated with COR symbols 658. Additionally, two hold-and-spin reels 652 in the second column of bonus hold-and-spin game 600 are pre-populated with COR symbol 658 and multiplier feature symbol 418, respectively.

FIGS. 8A-8D are exemplary user interfaces or screenshots after the triggering of bonus wheel game 700. More specifically, FIG. 8A is an exemplary user interface or screenshot of first display device 412A depicting a base reel game outcome that triggers bonus wheel game 700. In exemplary embodiments bonus wheel game 700 is triggered as a result of base reel game outcome including, depicting, and/or displaying at least one wheel feature symbol 422 in the plurality of mechanical reels 402-406 of base reel game 400. As shown in FIG. 8A, a plurality of wheel feature symbols 422 positioned, displayed, and/or linearly aligned in mechanical reels 402-406 during base reel game 400 triggers bonus wheel game 700 on display device 412B (see, FIGS. 8B-8D). In other exemplary embodiments, the depicting of one or more wheel feature symbols 422 in the base reel game outcome can trigger bonus wheel game 700, regardless of what symbol position and/or which mechanical reel 402-406 wheel feature symbols 422 are depicted in.

Referring to FIGS. 8B-8D, exemplary user interfaces or screenshots of a sequence of bonus wheel game 700 initiated after playing base reel game 400 (see, FIG. 8A) are displayed. Specifically, FIG. 8B is an exemplary user interface or screenshot after the plurality of wheel feature symbols 422 are displayed in the outcome of base reel game 400 (see, FIG. 8A), and distinct display device 412B initiates the displaying and/or presenting of bonus wheel game 700 to the player. Additionally, FIG. 8B is an exemplary user interface or screenshot of bonus wheel game 700 prior to spinning bonus wheel 442, FIG. 8C is an exemplary user interface or screenshot of bonus wheel 442 spinning during bonus wheel game 700, and FIG. 8D is an exemplary user interface or screenshot of a bonus wheel game outcome for bonus wheel game 700. In exemplary embodiments, a notification 762 is presented to the player on display device 412B to indicate and/or represent that bonus wheel game 700 has been triggered.

In exemplary embodiments, bonus wheel game 700 depicted on display device 412B includes bonus wheel 442. Bonus wheel 442 of bonus wheel game 700 includes a plurality of wedges 764. More specifically, bonus wheel 442 is formed and/or divided into a plurality of distinct wedges 764 disposed circumferentially about a center reference point. In the non-limiting example shown, at least a portion of the plurality of wedges 764 for bonus wheel 442 are sized distinctly and/or include distinct sizes. However, in other non-limiting examples (not shown), the plurality of wedges 764 may include identical sizes with respect to one another. Each wedge of the plurality of wedges 764 depicts a credit value feature symbol 766, a jackpot feature symbol 768, or a distinct hold-and-spin feature symbol 770. The credit value feature symbol 766 depicted, displayed, and/or associated with each wedge of the plurality of wedges 764 represents a predetermined credit value that can provide additional award credits to the player during bonus wheel game 700. As discussed herein, the credit value depicted in and/or associated with credit value feature symbol 766 is dependent, at least in part, on a wager value made by the player during base reel game 400. In exemplary embodiments, the higher the initial wager during base reel game 400, the higher the credit value associated with credit value feature symbol 766.

Jackpot feature symbol 768 of wedge(s) 764 are associated with and/or correspond to an indicated jackpot bonus 434-440 discussed herein. Additionally, distinct hold-and-spin feature symbol 770 of wedge(s) 764 are associated with and/or can trigger bonus hold-and-spin bonus game 600 (and possibly multiplier feature 500), as similarly discussed herein with respect to hold-and-spin feature symbol 420 (see, FIGS. 6D-6J). In an exemplary embodiment, credit value feature symbol 766, jackpot feature symbol 768, and/or hold-and-spin feature symbol 770 included within the plurality of wedges 764 are randomly generated and presented to the user or player on display device 412B during bonus wheel game 700. In the exemplary embodiment, bonus wheel 442 of bonus wheel game 700 includes eighteen (18) wedges 764. However, it is understood that bonus wheel 442 can include more or less wedges 764.

Additionally in exemplary embodiments, at least a portion of the plurality of wedges 764 are animated. For example, each distinct hold-and-spin feature symbol 770, depicting a plurality of eclipse phases, are animated, such that during bonus wheel game 700 (and/or any other game or feature) the eclipse phases change, transition, and/or are visually metamorphic.

Bonus wheel game 700 also includes at least one pointer 774. Pointer 774 is positioned adjacent to bonus wheel 442. During the spin and/or game play of bonus wheel game 700, pointer 774 visually identifies the wedge 764 of bonus wheel 442 that has been selected and/or awarded to the player. As shown in FIGS. 8B-8D, pointer 774 is formed and/or depicted as a triangle. However, it should be understood that pointer 774 can be formed as any shape, symbol, figure, and/or graphic that can readily identify wedges 764 of bonus wheel 442 during bonus wheel game 700.

FIG. 8D is an exemplary user interface or screenshot of bonus wheel game 700 that shows an exemplary bonus wheel game outcome for bonus wheel game 700. More specifically, FIG. 8D shows a user interface or screenshot depicting the bonus wheel game outcome for the spin for bonus wheel game 700. In the non-limiting example, bonus wheel game outcome awards the player “$200” credits. That is, when bonus wheel 442 stops spinning, pointer 774 of bonus wheel game 700 identifies wedge 764 that includes and/or corresponds to credit value feature symbol 766 equal to or depicting a “$200” credit value. Additionally, a notification 776 is provided to the player or user to indicate that bonus wheel game 700 has concluded. Notification 776 also indicates to the user or player the final prize or credit value awarded during bonus wheel game 700 (e.g., “WHEEL BONUS WINNER $200.00”). In the exemplary embodiment, the credit value associated with the bonus wheel game outcome is added to win meter 432, and bonus wheel game 700 ends. As a result of ending, display device 412B reverts back to base reel game 400 (see, FIG. 4B).

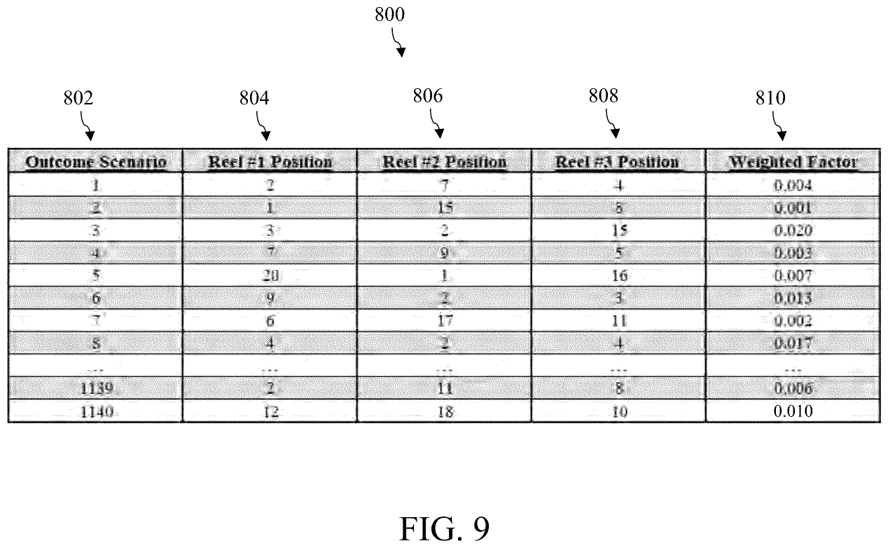

FIG. 9 is an example, single outcome table 800 defining various base reel game outcome scenarios for the plurality of mechanical reels 402-406 included in first display device 412A. In exemplary embodiments, the random generation of the base reel game outcome is determined, defined, and/or generated using single outcome table 800. As shown, single outcome table 800 includes a number of outcome scenarios 802, a reel position indicator 804-808 for each of the plurality of mechanical reels 402-406 included in first display device 412A, and a weighted factor 810 associated with each outcome scenario 802. In non-limiting examples where base reel game 400 is played on three (3) mechanical reels 402-406, each including twenty (20) reel stop positions, the number of possible unique outcome scenarios is 1,140. Each of the plurality of reel position indicator 804-808 identify one (1) of the twenty (20) possible reel stop positions for each of the plurality of reels 402-406 for each individual outcome scenario identified in outcome scenarios 802. Additionally, weighted factor 810 determines the likelihood in which the specific outcome scenarios 802 occur during base reel game 400.

Single outcome table 800 is stored in, for example, RNG conversion engine 320 of game processing architecture 300 (see, FIG. 3). Additionally, or alternatively, reel stop position tables (not shown) identifying each possible reel stop position for each of the plurality of mechanical reels 402-406 are also stored within RNG conversion engine 320, such that RNG engine 316 is communicatively coupled to and/or capable of communicating with both single outcome table 800 and the reel stop position tables stored within RNG conversion engine 320, as similarly described herein. During gameplay of base reel game 400, RNG engine 316 of game processing architecture 300 does not pull and/or generate a random number for each of the plurality of reels 402-406 (e.g., three (3) distinct RNGs) when initiating or playing base reel game 400 in order to determine a base reel game outcome. Rather, in order to determine the base reel game outcome, RNG engine 316 pulls or generates a single random number with reference to single outcome table 800, where the single number pulled by RNG engine 316 corresponds to one of the outcome scenarios 802 defined in single outcome table 800. Using single outcome table 800, reel stop positions for each of the plurality of mechanical reels 402-406, as identified by reel position indicators 804-808, are defined and/or associated with the outcome scenario 802 selected or identified by RNG engine 316. Additionally during the pull of the single number that corresponds to one of the outcome scenarios 802 defined in single outcome table 800, weighted factors for each scenario, as defined by weighted factor 810, influence the number generated. In response the generating and/or identifying one of the outcome scenarios 802, as well as the corresponding reel stop position for each reel 402-406, reels 402-406 subsequently stop during base reel game 400 in the predetermined position to provide the base reel game outcome.

As shown in FIG. 9, outcome scenario “1140” (e.g., outcome scenario 802) identified in single outcome table 800 predetermines, identifies, and/or defines the reel positions for each reel 402-406, and in turn generates the base reel game outcome for base reel game 400. For example, if outcome scenario “1140” is selected to define the base reel game outcome for base reel game 400, first mechanical reel 402 is spun and stops at reel stop position “12” as defined in reel position indicator 804, second mechanical reel 404 is spun and stops at reel stop position “18” as defined in reel position indicator 806, and third mechanical reel 406 is spun and stops at reel stop position “10” as defined in reel position indicator 808, respectively.

Although single outcome table 800 includes a corresponding number of outcome scenarios 802, it is to be understood that base reel game 400 can include more or less outcome scenarios. That is, depending upon, at least in part, outcome scenarios, the number of reels included in playing base reel game 400, the number of reel stop positions for each of the reels included in base reel game 400, and/or the credit values/features included in base reel game 400, single outcome table 800 can include more or less outcome scenarios 802.

A computer, controller, or server, such as those described herein, includes at least one processor or processing unit and a system memory. The computer, controller, or server typically has at least some form of computer readable non-transitory media. As used herein, the terms “processor” and “computer” and related terms, e.g., “processing device”, “computing device”, and “controller” are not limited to just those integrated circuits referred to in the art as a computer, but broadly refers to a microcontroller, a microcomputer, a programmable logic controller (PLC), an application specific integrated circuit, and other programmable circuits “configured to” carry out programmable instructions, and these terms are used interchangeably herein. In the implementations described herein, memory may include, but is not limited to, a computer-readable medium or computer storage media, volatile and nonvolatile media, removable and non-removable media implemented in any method or technology for storage of information such as computer readable instructions, data structures, program modules, or other data. Such memory includes a random access memory (RAM), computer storage media, communication media, and a computer-readable non-volatile medium, such as flash memory. Alternatively, a floppy disk, a compact disc—read only memory (CD-ROM), a magneto-optical disk (MOD), and/or a digital versatile disc (DVD) may also be used. Also, in the implementations described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary implementation, additional output channels may include, but not be limited to, an operator interface monitor.

As indicated above, the process may be embodied in computer software. The computer software could be supplied in a number of ways, for example on a tangible, non-transitory, computer readable storage medium, such as on any nonvolatile memory device (e.g. an EEPROM). Further, different parts of the computer software can be executed by different devices, such as, for example, in a client-server relationship. Persons skilled in the art will appreciate that computer software provides a series of instructions executable by the processor.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. An electronic gaming system comprising:
a plurality of mechanical reels included in a first display device, the plurality of mechanical reels including a plurality of game symbols;
at least one memory for storing instructions; and
a game controller in communication with the at least one memory and each of the plurality of mechanical reels, the game controller including at least one processor, wherein when the instructions are executed by the at least one processor, the at least one processor is configured to:
cause to be displayed on the first display device a base reel game played on the plurality of mechanical reels;
randomly generate a base reel game outcome using a single outcome table defining a plurality of outcome scenarios for the plurality of mechanical reels, each outcome scenario of the plurality of outcome scenarios including (i) a predetermined reel stop for each of the plurality of mechanical reels, and (ii) a weighted factor;
determine that the base reel game outcome triggers at least one of:
a multiplier feature corresponding to a multiplier feature symbol included in the plurality of game symbols,
a bonus hold-and-spin game corresponding to a hold-and-spin feature symbol included in the plurality of game symbols, or
a bonus wheel game corresponding to at least one wheel feature symbol included in the plurality of game symbols; and
cause to be displayed on a second display device at least one of the triggered multiplier feature, the triggered bonus hold-and-spin game, or the triggered bonus wheel game.

2. The electronic gaming system of claim 1, wherein in response to determining that the generated base reel game outcome triggers the multiplier feature corresponding to the multiplier feature symbol, the at least one processor further causes the game controller to:
determine the multiplier feature symbol is displayed in a predefined symbol position for the plurality of mechanical reels in the generated base reel game outcome.

3. The electronic gaming system of claim 2, wherein in response to causing to be displayed on the second display device the triggered, multiplier feature, the at least one processor further causes the game controller to:
cause to be displayed on the second display device an initial payline credit value based on the base reel game outcome;
define a multiplier value for the triggered, multiplier feature; and
cause to be displayed on the second display device a multiplier feature credit value, the multiplier feature credit value equal to the initial payline credit value multiplied by the defined, multiplier value.

4. The electronic gaming system of claim 1, wherein in response to determining that the generated base reel game outcome triggers the bonus hold-and-spin game corresponding to the hold-and-spin feature symbol, the at least one processor further causes the game controller to:
determine the hold-and-spin feature symbol is displayed in the plurality of mechanical reels of the generated base reel game outcome.

5. The electronic gaming system of claim 4, wherein in response to causing to be displayed on the second display device the triggered, bonus hold-and-spin game, the at least one processor further causes the game controller to:
cause to be displayed on the second display device a plurality of hold-and-spin reels including at least one of at least one blank symbol, at least one cash-on-reel (COR) symbol including a credit value, and the multiplier feature symbol.

6. The electronic gaming system of claim 5, wherein in response to causing to be displayed on the second display device the triggered, bonus hold-and-spin game, the at least one processor further causes the game controller to:
pre-populate at least one of the plurality of hold-and-spin reels with at least one COR symbol or the multiplier feature symbol based on the hold-and-spin feature symbol included in the base reel game outcome.

7. The electronic gaming system of claim 5, wherein in response to determining that a bonus hold-and-spin game outcome includes the multiplier feature symbol, the at least one processor further causes the game controller to:
cause to be displayed on the second display device an initial hold-and-spin credit value, the hold-and-spin credit value including a total credit value for all the COR symbols displayed in the plurality of hold-and-spin reels in the bonus hold-and-spin game outcome;
define a distinct multiplier value; and
cause to be displayed on the second display device a final hold-and-spin credit value, the final hold-and-spin credit value equal to the initial hold-and-spin credit value multiplied by the defined, distinct multiplier value.

8. The electronic gaming system of claim 1, wherein in response to determining that the generated base reel game outcome triggers the bonus wheel game corresponding to the at least one wheel feature symbol, the at least one processor further causes the game controller to:
determine a plurality of wheel feature symbols are displayed in the plurality of mechanical reels in the generated base reel game outcome.

9. The electronic gaming system of claim 8, wherein in response to causing to be displayed on the second display device the triggered, bonus wheel game, the at least one processor further causes the game controller to:
cause to be displayed on the second display device a bonus wheel of the bonus wheel game, the bonus wheel including a plurality of wedges,
wherein each of the plurality of wedges includes at least one credit value, at least one jackpot bonus symbol corresponding to a jackpot credit value, or a distinct, hold-and-spin feature symbol corresponding to the bonus hold-and-spin game.

10. A method of electronic gaming implemented on an electronic gaming machine, the method comprising:
causing to be displayed on a first display device a base reel game played on a plurality of mechanical reels, the plurality of mechanical reels including a plurality of game symbols;
randomly generating a base reel game outcome using a single outcome table defining a plurality of outcome scenarios for the plurality of mechanical reels, each outcome scenario of the plurality of outcome scenarios including (i) a predetermined reel stop for each of the plurality of mechanical reels, and (ii) a weighted factor;
determining that the base reel game outcome triggers at least one of:
a multiplier feature corresponding to a multiplier feature symbol included in the plurality of game symbols,
a bonus hold-and-spin game corresponding to a hold-and-spin feature symbol included in the plurality of game symbols, or
a bonus wheel game corresponding to at least one wheel feature symbol included in the plurality of game symbols; and
causing to be displayed on a second display device at least one of the triggered multiplier feature, the triggered bonus hold-and-spin game, or the triggered bonus wheel game.

11. The method of claim 10, wherein the determining that the generated base reel game outcome triggers the multiplier feature corresponding to the multiplier feature symbol, further includes:
determining the multiplier feature symbol is displayed in a predefined symbol position for the plurality of mechanical reels in the generated base reel game outcome.

12. The method of claim 11, wherein the causing to be displayed on the second display device the triggered, multiplier feature further includes:
causing to be displayed on the second display device an initial payline credit value based on the base reel game outcome;
defining a multiplier value for the triggered, multiplier feature; and
causing to be displayed on the second display device a multiplier feature credit value, the multiplier feature credit value equal to the initial payline credit value multiplied by the defined, multiplier value.

13. The method of claim 10, wherein the determining that the generated base reel game outcome triggers the bonus hold-and-spin game corresponding to the hold-and-spin feature symbol further includes:
determining the hold-and-spin feature symbol is displayed in the plurality of mechanical reels of the generated base reel game outcome.

14. The method of claim 13, wherein the causing to be displayed on the second display device the triggered, bonus hold-and-spin game further includes:
causing to be displayed on the second display device a plurality of hold-and-spin reels including at least one of at least one blank symbol, at least one cash-on-reel (COR) symbol including a credit value, and the multiplier feature symbol.

15. The method of claim 14, wherein the causing to be displayed on the second display device the triggered, bonus hold-and-spin game further includes:
pre-populating at least one of the plurality of hold-and-spin reels with at least one COR symbol or the multiplier feature symbol based on the hold-and-spin feature symbol included in the base reel game outcome.

16. The method of claim 14, wherein the determining that a bonus hold-and-spin game outcome includes the multiplier feature symbol further includes:
causing to be displayed on the second display device an initial hold-and-spin credit value, the hold-and-spin credit value including a total credit value for all the COR symbols displayed in the plurality of hold-and-spin reels in the bonus hold-and-spin game outcome;
defining a distinct multiplier value; and
causing to be displayed on the second display device a final hold-and-spin credit value, the final hold-and-spin credit value equal to the initial hold-and-spin credit value multiplied by the defined, distinct multiplier value.

17. The method of claim 10, wherein the determining that the generated base reel game outcome triggers the bonus wheel game corresponding to the at least one wheel feature symbol further includes:
determining a plurality of wheel feature symbols are displayed in the plurality of mechanical reels in the generated base reel game outcome.

18. The method of claim 17, wherein the causing to be displayed on the second display device the triggered, bonus wheel game further includes:
causing to be displayed on the second display device a bonus wheel of the bonus wheel game, the bonus wheel including a plurality of wedges,
wherein each of the plurality of wedges includes at least one credit value, at least one jackpot bonus symbol corresponding to a jackpot credit value, or a distinct, hold-and-spin feature symbol corresponding to the bonus hold-and-spin game.

19. A non-transitory computer-readable storage medium with instructions stored thereon that, in response to execution by at least one processor, cause the at least one processor to:
cause to be displayed on a first display device a base reel game played on a plurality of mechanical reels, the plurality of mechanical reels including a plurality of game symbols;
randomly generate a base reel game outcome using a single outcome table defining a plurality of outcome scenarios for the plurality of mechanical reels, each outcome scenario of the plurality of outcome scenarios including (i) a predetermined reel stop for each of the plurality of mechanical reels, and (ii) a weighted factor;
determine that the base reel game outcome triggers at least one of:
a multiplier feature corresponding to a multiplier feature symbol included in the plurality of game symbols,
a bonus hold-and-spin game corresponding to a hold-and-spin feature symbol included in the plurality of game symbols, or
a bonus wheel game corresponding to at least one wheel feature symbol included in the plurality of game symbols; and
cause to be displayed on a second display device at least one of the triggered multiplier feature, the triggered bonus hold-and-spin game, or the triggered bonus wheel game.

20. The non-transitory computer-readable storage medium of claim 19, wherein in response to determining that the generated base reel game outcome triggers the multiplier feature corresponding to the multiplier feature symbol, the instructions, when executed, cause the at least one processor to:
determine the multiplier feature symbol is displayed in a predefined symbol position for the plurality of mechanical reels in the generated base reel game outcome.
